(19) United States
(12) Patent Application Publication
(10) Pub. No.: US 2007/0140553 A1
(43) Pub. Date: Jun. 21, 2007

(54) Dental colorimetry apparatus

(75) Inventor: Masaya Katsumata, Kanagawa (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/636,753

(22) Filed: Dec. 11, 2006

(30) Foreign Application Priority Data
Dec. 19, 2005 (JP) 2005-365606

(51) Int. Cl. G06K 9/00

(52) U.S. Cl. 382/162

(57) ABSTRACT

An object is to represent the difference of colors of a vital tooth and a tooth sample in a highly precise manner and to compare the colors in a relatively easy manner. The invention provides a dental colorimetry apparatus including a shade-guide-information storage unit configured to store acquired image data of a tooth sample and calorimetric information of each pixel acquired on the basis of the acquired image data; a pixel extracting unit configured to acquire reference calorimetric information used as a reference when carrying out a comparison with the vital tooth, to compare the reference calorimetric information and the calorimetric information for each pixel of the tooth sample, and to extract pixels whose comparison results satisfy a predetermined condition; an image-generating unit configured to create a sample comparison image in which a third pixel group including pixels extracted by the pixel extracting unit and a fourth pixel group including pixels that are not extracted are represented by different colors; and a display device configured to display the sample comparison image created by the image-generating unit.

### BACKGROUND OF THE INVENTION

1. Field of the Invention

The present invention relates to a dental colorimetry apparatus designed to reconfigured an object in a highly accurate manner and to a system, method, and program for the same.

This application is based on Japanese Patent Application No. 2005-365606, the content of which is incorporated herein by reference.

2. Description of Related Art

In recent years, there has been increased interest in beauty and health. In the beauty industry, for example, whitening for reducing melanin pigment in the skin has become a fashionable means in the pursuit of beauty. Skin-diagnosis camera systems which are designed to allow observation of magnified images of the skin on a monitor are used in conventional skin diagnosis; for example, they are used in dermatology, aesthetic salons, beauty counseling, and so on. In the case of dermatology, for example, by observing images of the grooves and bumps in the skin, features of the skin surface can be diagnosed and counseling can be given.

In the field of dentistry, dental treatments such as ceramic crowns are another aspect of the pursuit of beauty. The procedure of applying ceramic crowns involves first preparing a crown (a prosthetic tooth crown made of ceramic) having a color that is similar to the color of the patient's original tooth, and this crown is then overlaid on the patient's tooth. In ceramic crown treatment, preparation of the prosthetic crown is critical.

Conventionally, crowns are prepared by the process described below.

First, in a dental clinic, an image of a patient's oral cavity is captured by a dentist. For example, a photograph of the entire oval cavity, including a plurality of teeth, is taken and an image of the surface of a vital tooth is acquired. This image acquisition is performed using a digital camera designed for dentistry.

Then, among samples of different shades of color (hereinafter referred to as a “shade guide”), the dentist selects a shade guide having the color closest to the patient's vital tooth (this procedure is referred to as a “shade take” below). A shade guide, for example, is constructed by processing different-colored ceramic materials into the shape of teeth. When the dentist completes the procedure described above, the acquired photograph and a unique identification number assigned to the selected shade guide is sent to a dental laboratory which makes crowns. Then, the crown is produced in the dental laboratory based on this information.

However, the shade take described above is not entirely quantitative because it depends on the subjective judgment of the dentist. Also, the appearance of the shade guide and the patient's tooth color may differ depending on various factors, such as the color of the gum, the environmental conditions, the illumination (for example, the illumination direction and color), the level of fatigue of the dentist, and so on. Therefore, there are problems in that it is very difficult to select the optimal shade guide and a burden is placed on the dentist.

To reduce the above-described burden on the dentist, an apparatus that supports the shade take procedure by providing a function for automatically selecting a shade guide that has the color closest to the vital tooth has been proposed.

For example, Publication of Japanese Patent No. 3710802 (hereinafter referred to as Patent Document 1) discloses a technology including the steps of storing in advance a data table linking identification-information data of a plurality of tooth reference colors and color-information data of the L*a*b* color system of the tooth reference colors; inputting image data of images of a vital tooth and reference object (equivalent to the shade guide described above) having the color tone of the tooth reference colors; correcting the color tone of the vital tooth by calculating a color-correction value that substantially matches the color-information data of the L*a*b* color system of the tooth reference colors of the reference object analyzed within the image data with the identification-information data of the tooth reference colors; and extracting and outputting the identification-information data of the tooth reference colors of the color-information data that matches or approximates the color-information data of the corrected color tone of the vital tooth.

However, there are problems in the invention disclosed in Patent Document 1 in that only a rough comparison result can be obtained because the color-information data of the L*a*b* color system in a predetermined area defined on the vital tooth and the color-information data of the L*a*b* color system in a predetermined area defined on the reference object are compared in an approximate manner and detailed comparison results for the predetermined areas cannot be obtained.

Furthermore, according to the invention disclosed in Patent Document 1, since the comparison results are represented by numerical values, it is difficult for users, such as dentists and dental technicians, to grasp the differences between the areas.

### BRIEF SUMMARY OF THE INVENTION

The present invention provides a dental colorimetry apparatus, system, method, and program that are capable of representing the difference of colors of a vital tooth and a tooth sample in a highly accurate manner and in a way that allows comparison of the colors in relatively easy manner.

A first aspect of the present invention provides a dental colorimetry apparatus including a first storage unit configured to store, for each pixel, acquired image data of a vital tooth and calorimetric information that is acquired on the basis of the acquired image data; a reference acquisition unit configured to acquire reference calorimetric information that is used as a reference when comparing the calorimetric information; a first extracting unit configured to compare the reference calorimetric information and the calorimetric information of each pixel of the vital tooth and to extract pixels whose comparison result satisfies a predetermined condition; a first image-generating unit configured to create a vital tooth comparison image representing, in different colors, a first pixel group including pixels extracted by the first extracting unit and a second pixel group including pixels that are not extracted; and a display control unit configured to display the vital tooth comparison image created by the first image-generating unit.

According to this configuration, the reference calorimetric information acquired by the reference acquisition unit is transferred to the first extracting unit, and the reference calorimetric information and the calorimetric information of the vital tooth are compared for each pixel in the first extracting unit. Moreover, the first extracting unit determines whether or not the comparison result for each pixel satisfies a predetermined condition, extracts pixels that satisfy the predetermined condition, and transfer this pixel information to the first image-generating unit. At the first image-generating unit, a vital tooth comparison image in which the first pixel group including pixels extracted by the first extracting unit and the second pixel group including pixels that are not extracted by the first extracting unit are represented by different colors is created. The vital tooth comparison image is displayed on, for example, a screen of a monitor, by the display control unit.

Thus, according to this aspect, since pixels are separated into pixels that satisfy a predetermined condition and pixels that do not satisfy a predetermined condition according to the relationship between the calorimetric information and the reference calorimetric information, and a vital tooth comparison image represented in such a manner that the separated pixels are displayed in different colors is displayed, by viewing the screen, the user can easily recognize which region of the vital tooth satisfies the predetermined condition.

The “calorimetric information” is, for example, chroma values, spectral curves, or color temperature or, more specifically, RGB values, L*a*b* values, CMYK values, XYZ values, LCH values, spectral compositions, spectral reflectance, or color temperature values. The second storage unit only has to be able to store at least one type of value, such as the RGB values.

“Different colors” refers to, for example, representing the difference of a third pixel group and a fourth pixel group in the sample comparison image in a visually recognizable manner. For example, it is possible to represent the difference by pixels of different colors or pixels of the same color but different darkness of brightness. Furthermore, “different colors” refers to representing dark and light using halftones or a mesh.

The above-described dental colorimetry apparatus may further include a second storage unit configured to store, for each pixel, acquired image data of a tooth sample and calorimetric information that is acquired on the basis of the acquired image data; a second extraction unit configured to compare the reference calorimetric information and the calorimetric information of each pixel of the tooth sample and to extract pixels whose comparison result satisfies a predetermined condition; and a second image-generating unit configured to create a sample comparison image representing, in different colors, a third pixel group including pixels extracted by the second extracting unit and a fourth pixel group including pixels that are not extracted, wherein the display control unit displays the sample comparison image created by the second image-generating unit and the vital tooth comparison image.

According to this configuration, the reference calorimetric information acquired by the reference acquisition unit is transferred also to the second extracting unit, and the reference calorimetric information and the calorimetric information of the tooth sample are compared for each pixel at the second extracting unit. Moreover, the second extracting unit determines whether or not the comparison result for each pixel satisfies a predetermined condition, extracts pixels that satisfy the predetermined condition, and transfer this pixel information to the second image-generating unit. At the second image-generating unit, a sample comparison image in which the third pixel group including pixels extracted by the first extracting unit and the fourth pixel group including pixels that are not extracted by the second extracting unit are represented by different colors is created. The sample comparison image is displayed, together with the above-described vital tooth comparison image, on, for example, a screen of a monitor, by the display control unit.

Thus, according to this aspect, since pixels of the sample are separated into pixels that satisfy a predetermined condition and pixels that do not satisfy a predetermined condition according to the relationship between the calorimetric information and the reference calorimetric information, and a sample comparison image represented in such a manner that the separated pixels are displayed in different colors is displayed, by viewing the screen, the user can easily recognize which region of the tooth sample satisfies the predetermined condition.

Furthermore, since the vital tooth comparison image and the sample comparison image are displayed on the same screen, the characteristics of the vital tooth and the characteristics of the tooth sample can be easily compared on the basis of these images.

For the above-described dental colorimetry apparatus, in the sample comparison image and the vital tooth comparison image, the first pixel group and the third pixel group may be represented by the same color and the second pixel group and the fourth pixel group may be represented by the same color.

According to this configuration, since the colors of the pixels that do not satisfy the predetermined condition can be the same color in the sample comparison image and the vital tooth comparison image, the user viewing the screen can easily compare the two images.

In the above-described dental colorimetry apparatus, the first image-generating unit may change at least one of the brightness, chromaticity, and hue of each pixel in the vital tooth comparison image according to the calorimetric information of each pixel, and the second image-generating unit may change at least one of the brightness, chromaticity, and hue of each pixel in the sample comparison image according to the calorimetric information of each pixel.

According to this configuration, since at least one of the brightness, chromaticity, and hue changes according to the calorimetric information of each pixel in the sample comparison image and the vital tooth comparison image, the user can visually confirm how the calorimetric information of each pixel changes by viewing the screen. In this way, the characteristics of the tooth sample and the characteristics of the vital tooth can be confirmed in more detail.

In the above-described dental colorimetry apparatus, in the vital tooth comparison image created by the first image-generating unit, the pixels included in the first pixel group may be represented by the acquired image data of the vital tooth, and in the sample comparison image created by the second image-generating unit, the pixels included in the third pixel group may be represented by the acquired image data of the tooth sample.

According to this configuration, since for pixels that satisfy the predetermined condition in the sample comparison image and the vital tooth comparison image, acquired image data is employed. In this way, for regions that satisfy the predetermined condition, the colors of the tooth sample and the vital tooth are reproduced in the acquired images as substantially the same colors. Therefore, the user can confirm even slight differences in the colors. In such a case, it is preferable to represent the pixels that are determined as not satisfying the predetermined condition, i.e., pixels included in the second and fourth pixel groups, with reduced brightness, chromaticity, or hue. In this way, since the regions employing acquired image data are enhanced compared with other regions, the colors of the regions can be easily compared.

In the above-described dental colorimetry apparatus, the first image-generating unit may change at least one of the brightness, chromaticity, and hue of each pixel included in the second image group of the vital tooth comparison image according to the calorimetric information of each pixel, and the second image-generating unit may change at least one of the brightness, chromaticity, and hue of each pixel included in the fourth image group of the sample comparison image according to the calorimetric information of each pixel.

According to this configuration, since pixels that do not satisfy the predetermined condition in the sample comparison image and the vital tooth comparison image are represented such that at least one of the brightness, chromaticity, and hue changes according to the calorimetric information of the pixels, the user can recognize in detail the calorimetric information of pixels that do not satisfy the predetermined condition by viewing the screen.

In the above-described dental colorimetry apparatus, the display control unit may display a reference input section for inputting the reference calorimetric information on a screen displaying the vital tooth comparison image.

According to this configuration, since a reference input section for inputting reference calorimetric information is displayed on the screen displaying the vital tooth comparison image, the user can input desired reference calorimetric information using this reference input section.

In the above-described dental colorimetry apparatus, the display control unit may display a condition input section for inputting the predetermined condition on a screen displaying the vital tooth comparison image.

According to this configuration, since a reference input section for inputting reference calorimetric information is displayed on the screen displaying the vital tooth comparison image, the user can input desired reference calorimetric information using this reference input section.

The above-described dental colorimetry apparatus further includes a region-specifying unit configured to specify a region on a vital tooth to be measured, the region being included in an acquired image of the oral cavity acquired by an image acquisition apparatus; a measurement-region setting unit configured to define at least one measurement region in the specified region of the vital tooth; and a sample selecting unit configured to select at least one tooth sample approximating a spectrum of the measurement region from a plurality of tooth samples registered in advance, wherein the second extracting unit compares, for each pixel, the reference calorimetric information and colorimetric information of the tooth sample selected by the sample selecting unit.

According to this configuration, a region of the vital tooth to be measured is specified in an acquired image of the oral cavity acquired by the image acquisition apparatus using the region-specifying unit; the measurement-region setting unit sets at least one measurement region in the specified region of the vital tooth; the sample selecting unit selects at least one tooth sample approximating the spectrum of the measurement region from a plurality of tooth samples registered in advance; and calorimetric information related to at least one of the selected tooth samples is acquired from the second storage unit and is transferred to the second extracting unit. In this way, the reference calorimetric information and calorimetric information of the tooth sample selected by the sample selecting unit are compared for each pixel. Accordingly, a tooth sample having a characteristic that is most similar to that of the vital tooth can be compared.

A second aspect of the present invention provides a dental colorimetry system including an image-acquisition apparatus configured to acquire an image of an oral cavity; a dental colorimetry apparatus configured to process the image acquired by the image-acquisition apparatus; and a display device configured to display an image processed by the dental colorimetry apparatus, wherein the dental colorimetry apparatus includes a first storage unit configured to store, for each pixel, acquired image data of a vital tooth and calorimetric information that is acquired on the basis of the acquired image data, a reference acquisition unit configured to acquire reference calorimetric information that is used as a reference when comparing the calorimetric information, a first extracting unit configured to compare the reference calorimetric information and the calorimetric information of each pixel of the vital tooth and to extract pixels whose comparison result satisfies a predetermined condition, a first image-generating unit configured to create a vital tooth comparison image representing, in different colors, a first pixel group including pixels extracted by the first extracting unit and a second pixel group including pixels that are not extracted, and a display control unit configured to display the vital tooth comparison image created by the first image-generating unit.

In the above-described dental colorimetry system, the dental colorimetry apparatus may further include a second storage unit configured to store, for each pixel, acquired image data of a tooth sample and calorimetric information that is acquired on the basis of the acquired image data; a second extraction unit configured to compare the reference calorimetric information and the calorimetric information of each pixel of the tooth sample and to extract pixels whose comparison result satisfies a predetermined condition; and a second image-generating unit configured to create a sample comparison image representing, in different colors, a third pixel group including pixels extracted by the second extracting unit and a fourth pixel group including pixels that are not extracted, wherein the display control unit displays the sample comparison image created by the second image-generating unit and the vital tooth comparison image.

A third aspect of the present invention provides a dental colorimetry method including a reference acquiring step for acquiring reference calorimetric information that is used as a reference when comparing the calorimetric information that is acquired on the basis of the acquired image data of a vital tooth; a first extraction step for comparing the calorimetric information of each pixel of the vital tooth and the reference calorimetric information and extracting pixels whose comparison result satisfies a predetermined condition; a first image-generation step for creating a vital tooth comparison image representing, in different colors, a first pixel group including pixels extracted in the first extraction step and a second pixel group including pixels that are not extracted; and a display control step for displaying the vital tooth comparison image.

The dental colorimetry method may further include a second extraction step for comparing the calorimetric information of each pixel, the calorimetric information having been acquired on the basis of the acquired image data of a tooth sample, and the reference calorimetric information and extracting pixels whose comparison result satisfies a predetermined condition; and a second image-generation step for creating a sample comparison image representing, in different colors, a third pixel group including pixels extracted in the second extraction step and a fourth pixel group including pixels that are not extracted, wherein the sample comparison image and the vital tooth comparison image are displayed in the display control step.

A fourth aspect of the present invention provides a dental colorimetry program to be executed by a computer including reference acquiring processing for acquiring reference calorimetric information that is used as a reference when comparing the calorimetric information that is acquired on the basis of the acquired image data of a vital tooth; first extraction processing for comparing the calorimetric information of each pixel of the vital tooth and the reference calorimetric information and extracting pixels whose comparison result satisfies a predetermined condition; first image-generation processing for creating a vital tooth comparison image representing, in different colors, a first pixel group including pixels extracted by the first extraction processing and a second pixel group including pixels that are not extracted; and display control processing for displaying the vital tooth comparison image.

The above-described dental colorimetry program may further include second extraction processing for comparing the calorimetric information of each pixel, the calorimetric information having been acquired on the basis of the acquired image data of a tooth sample, and the reference calorimetric information and extracting pixels whose comparison result satisfies a predetermined condition; and second image-generation processing for creating a sample comparison image representing, in different colors, a third pixel group including pixels extracted by the second extraction processing and a fourth pixel group including pixels that are not extracted, wherein the sample comparison image and the vital tooth comparison image are displayed in the display control processing.

According to the above-described dental colorimetry program, in the sample comparison image and the vital tooth comparison image, the first pixel group and the third pixel group may be represented by the same color and the second pixel group and the fourth pixel group may be represented by the same color.

According to the above-described dental colorimetry program, in the first image generation processing, at least one of the brightness, chromaticity, and hue of each pixel in the vital tooth comparison image may be changed according to the calorimetric information of each pixel, and in the second image generation processing, at least one of the brightness, chromaticity, and hue of each pixel in the sample comparison image may be changed according to the calorimetric information of each pixel.

According to the above-described dental colorimetry program, in the vital tooth comparison image created in the first image generation processing, the pixels included in the first pixel group may be represented by the acquired image data of the vital tooth, and in the sample comparison image created in the second image generation processing, the pixels included in the third pixel group may be represented by the acquired image data of the tooth sample.

According to the above-described dental colorimetry program, in the first image generation processing, at least one of the brightness, chromaticity, and hue of each pixel included in the second image group of the vital tooth comparison image may be changed according to the calorimetric information of each pixel, and in the second image generation processing, at least one of the brightness, chromaticity, and hue of each pixel included in the fourth image group of the sample comparison image may be changed according to the calorimetric information of each pixel.

According to the above-described dental colorimetry program, in the display control processing, a reference input section for inputting the reference calorimetric information may be displayed on a screen displaying the vital tooth comparison image.

According to the above-described dental colorimetry program, in the display control processing, a condition input section for inputting the predetermined condition may be displayed on a screen displaying the vital tooth comparison image.

The above-described dental colorimetry program may further include region-specifying processing for specifying a region on a vital tooth to be measured, the region being included in an acquired image of the oral cavity acquired by an image acquisition apparatus; measurement-region setting processing for defining at least one measurement region in the specified region on the vital tooth; and sample selection processing for selecting at least one tooth sample approximating a spectrum of the measurement region from a plurality of tooth samples registered in advance, wherein in the second extraction processing, the reference calorimetric information and calorimetric information of the tooth sample are compared for each pixel.

The present invention is advantageous in that the color difference of the vital tooth and the tooth sample can be represented in a highly accurate manner and are represented in a way that allows comparison to be easily carried out.

### BRIEF DESCRIPTION OF THE SEVERAL VIEWS OF THE DRAWINGS

FIG. 1 is a block diagram showing, in outline, the configuration of an image-acquisition apparatus and a cradle according to a first embodiment of the present invention.

FIG. 2 is a graph showing the spectra of a light source illustrated in FIG. 1.

FIG. 3 is a graph for explaining signal correction.

FIG. 4 is a block diagram showing, in outline, the configuration of a dental colorimetry apparatus according to the first embodiment of the present invention.

FIG. 5 is a schematic diagram of the internal configuration of a spectrum-estimation computing unit illustrated in FIG. 4.

FIGS. 6A and 6B are graphs for explaining input gamma correction.

FIG. 7 is a diagram showing an example of a low-pass filter applied to an R signal and a B signal in a pixel interpolation.

FIG. 8 is a diagram showing an example of a low-pass filter applied to a G signal in the pixel interpolation.

FIG. 9 is a graph showing an example of a reflectance spectrum of a tooth (number of samples, n=2).

FIG. 10 is a graph showing an example of the reflectance spectrum of gums (number of samples, n=5).

FIG. 11 is a diagram for explaining a method of specifying a tooth region according to the first embodiment of the present invention.

FIG. 12 is a diagram showing an example of measurement regions defined in a measurement-region defining process.

FIG. 13 is a diagram showing an example of a display screen.

FIG. 14 is a diagram showing an example of a display screen.

FIG. 15 is a flow chart showing the process carried out by the dental colorimetry apparatus according to the first embodiment of the present invention.

FIG. 16 is a block diagram showing, in outline, the configuration of a dental colorimetry apparatus according to a second embodiment of the present invention.

FIG. 17 is a flow chart showing the process carried out by the dental colorimetry apparatus according to the second embodiment of the present invention.

### DETAILED DESCRIPTION OF THE INVENTION

Embodiments of a dental colorimetry system will be described below with reference to the drawings.

### First Embodiment

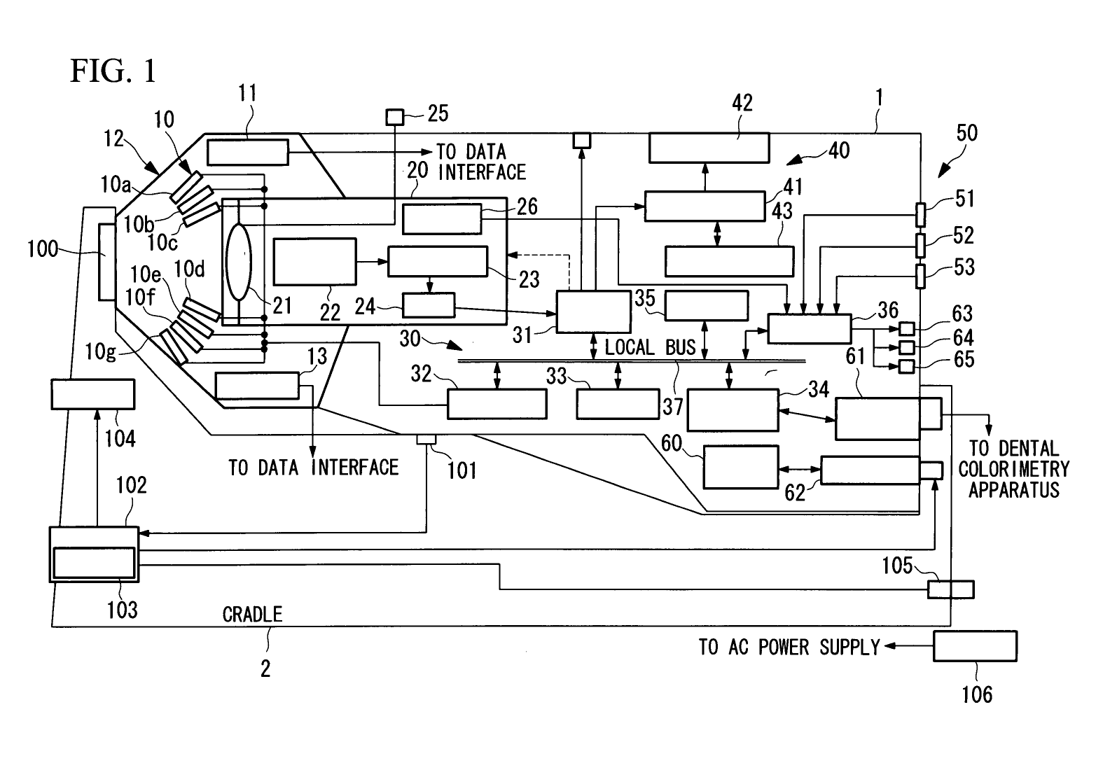

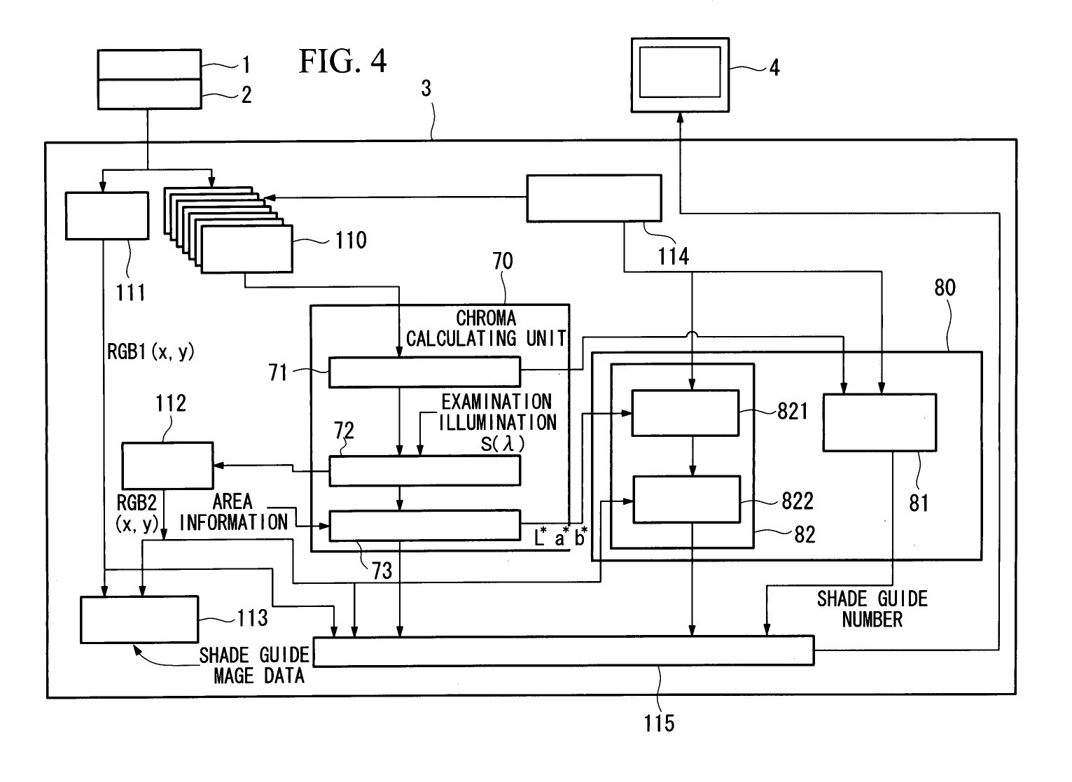

As shown in FIGS. 1 and 4, a dental colorimetry system according to the first embodiment includes an image-acquisition apparatus 1, a cradle 2, a dental colorimetry apparatus 3, and a display device 4.

As shown in FIG. 1, the image-acquisition apparatus 1 includes a light source 10, an image-acquisition unit 20, an image-acquisition control unit 30, a display unit 40, and an operating unit 50 as the main constituent elements thereof.

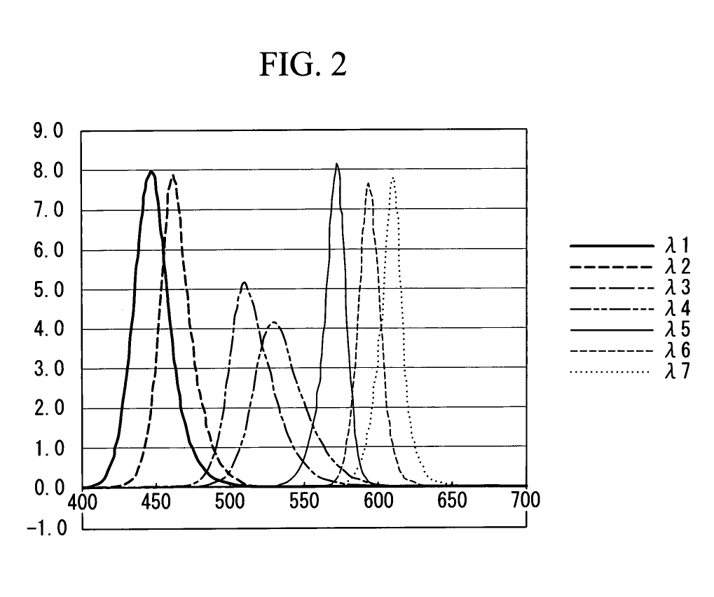

The light source 10 is disposed close to the tip of the image-acquisition apparatus 1 and emits illumination light of at least four different wavelength bands for illuminating an object. The light source 10 is provided with seven light sources 10a to 10g which emit light in different wavelength bands. Each light source 10a to 10g includes four light emitting diodes (LEDs). As shown in FIG. 2, the central wavelengths thereof are as follows: the light source 10a, about 450 nm; the light source 10b, about 465 nm; the light source 10c, about 505 nm; the light source 10d, about 525 nm; the light source 10e, about 575 nm; the light source 10f, about 605 nm; and the light source 10g, about 630 nm. Emission-spectrum information about these LEDs is stored in an LED memory 11 and is used in the dental colorimetry apparatus 3, which is described later.

These light sources 10a to 10g are disposed, for example, in the form of a ring. Their arrangement is not particularly limited; for example, the four LEDs may be arranged in decreasing order of wavelength, in reverse order, or randomly. In addition to all of the LEDs being disposed so as to form a single ring, they may be disposed so that the LEDs are divided into a plurality of groups and each group forms one ring. The configuration of the LEDs is not limited to the ring shape described above; it is possible to employ any configuration, such as a cross-shaped arrangement, a rectangular arrangement, a horizontal line arrangement, a vertical line arrangement, or a random arrangement, so long as they do not obstruct image acquisition by the image-acquisition unit 20, which is described later. The light emitting elements of the light source 10 are not limited to LEDs; for example, it is possible to use another type of light emitting element or a semiconductor laser such as a laser diode (LD).

In the image-acquisition apparatus 1, an illumination optical system (not shown) for radiating the illumination light from the light source 10 substantially uniformly over the surface of the object is provided at the object side of the light source 10. A temperature sensor 13 for detecting the temperature of the LEDs is provided in the vicinity of the light source 10.

The image-acquisition unit 20 is formed of an image-acquisition lens 21, an RGB color image-acquisition device 22, a signal processor 23, and an analog-to-digital (A/D) converter 24. The image-acquisition lens 21 forms an image of the object illuminated by the light source 10. The RGB color image-acquisition device 22 acquires an image of the object which is imaged by the image-acquisition lens 21 and outputs an image signal. The RGB color image-acquisition device 22 is formed, for example, of a CCD, and the sensor responsivity thereof substantially covers a wide visible region of the spectrum. The CCD may be a monochrome or color device. The RGB color image-acquisition device 22 is not limited to a CCD; it is possible to use other types of devices, such as CMOS image sensors.

The signal processor 23 subjects the analog signal output from the RGB image-acquisition device 22 to gain correction, offset correction, and so on. The A/D converter 24 converts the analog signal output from the signal processor 23 into a digital signal. A focus lever 25 for adjusting the focus is connected to the image-acquisition lens 21. This focus lever 25 is used to manually adjust the focus, and a position detector 26 for detecting the position of the focus lever 25 is provided.

The image-acquisition control unit 30 is formed of a CPU 31, an LED driver 32, a data interface 33, a communication interface controller 34, an image memory 35, and an operating-unit interface 36. These components are each connected to a local bus 37 and are configured to enable transmission and reception of data via the local bus 37.

The CPU 31 controls the image-acquisition unit 20, records a spectral image of the object acquired and processed by the image-acquisition unit 20 in the image memory 35 via the local bus 37, and outputs the image to an LCD controller 41, which is described later. The LED driver 32 controls the light emission of each LED provided in the light source 10. The data interface 33 receives the contents of the LED memory 11 and information from the temperature sensor 13, which is provided at the light source 10. The communication interface controller 34 is connected to a communication-interface contact point 61, which is used for external connection, and has a function for performing communication via a USB 2.0 connection, for example. The operating-unit interface 36 is connected to various operating buttons provided on the operating unit 50, which is described later, and functions as an interface for forwarding instructions input via the operating unit 50 to the CPU 31 via the local bus 37. The image memory 35 temporarily stores image data acquired in the image-acquisition unit 20. In this embodiment, the image memory 35 has sufficient capacity for storing at least seven spectral images and one RGB color image.

The display unit 40 is formed of the LCD controller 41 and a liquid crystal display (LCD) 42. The LCD controller 41 displays on the LCD 42 an image based on the image signal sent from the CPU 31, for example, the image currently being acquired by the image-acquisition unit 20 or a previously acquired image. As required, an image pattern stored in an overlay memory 43 may be superimposed on the image obtained from the CPU 31 and displayed on the LCD 42. The image pattern stored in the overlay memory 43 is, for example, a horizontal line for acquiring an image of the entire tooth horizontally, a cross line perpendicular thereto, an image-acquisition mode, an identification number of the acquired tooth, and so forth.

The operating unit 50 is provided with various operating switches and operating buttons for the user to input an instruction to commence spectral image acquisition and an instruction to commence or terminate moving-image acquisition. More specifically, the operating unit 50 includes an image-acquisition-mode switch 51, a shutter button 52, a viewer control button 53, and so forth. The image-acquisition-mode switch 51 is for switching between standard RGB image-acquisition and multispectral image acquisition. The viewer control button 53 is a switch for changing the image displayed on the LCD 42.

The image-acquisition apparatus 1 has a built-in lithium battery 60. This lithium battery 60, which supplies electrical power to each component of the image-acquisition apparatus 1, is connected to a connection point 62 for charging. A battery LED 63 for indicating the charging status of this lithium battery is provided. In addition, a power LED 64 for indicating the status of the camera and an alarm buzzer 65 for indicating a warning during image acquisition are also provided in the image-acquisition apparatus 1.

The battery LED 63 is provided with three LEDs, for example, red, yellow, and green LEDs. The battery LED 63 indicates that the lithium battery 60 is sufficiently charged by glowing green; that the battery charge is low by glowing yellow, in other words, that charging is required; and that the battery charge is extremely low by glowing red, in other words, that charging is urgently required.

The power LED 64 is provided with two LEDs, for example red and green LEDs. The power LED 64 indicates that image-acquisition preparation has been completed by glowing green; that image-acquisition preparation is currently underway (initial warm-up and so on) by flashing green; and that the battery is currently being charged by glowing red.

The alarm buzzer 65 indicates that the acquired image data is invalid by issuing an alarm sound.

The cradle 2 supporting the image-acquisition apparatus 1 includes a color chart 100 for calibrating the image-acquisition unit 20; a microswitch 101 for determining whether or not the image-acquisition apparatus 1 is installed in the correct position; a power switch 102 for turning the power supply on and off; a power lamp 103 which turns on and off in conjunction with the on and off states of the power switch 102; and an installed lamp 104 for indicating whether or not the image-acquisition apparatus 1 is installed in the correct position.

The installed lamp 104 glows green when, for example, the image-acquisition apparatus 1 is installed in the correct position and glows red when it is not installed. A power connector 105 is provided on the cradle 2, and an AC adaptor 106 is connected thereto. When the charge of the lithium battery 60 provided in the image-acquisition apparatus 1 is reduced and the battery LED glows yellow or red, the cradle 2 is designed such that charging of the lithium battery starts when the image-acquisition apparatus 1 is placed in the cradle 2.

The image-acquisition apparatus 1 of the dental colorimetry system having such a configuration can perform both multispectral image acquisition and RGB image acquisition. In multispectral image acquisition, illumination light beams of seven wavelength bands (illumination light beams of seven colors) are sequentially radiated onto the object, and seven spectral images of the object are acquired as still images. One possible RGB image-acquisition method is a method in which image acquisition of an object illuminated with natural light or room light, rather than illumination light of seven colors, is carried out using an RGB color CCD provided in the apparatus, just like a standard digital camera. By selecting one or more illumination beams from the illumination beams of seven colors as three RGB illumination beams and radiating them sequentially, it is also possible to acquire frame-sequential still images.

Among these image-acquisition modes, the RGB mode is used when acquiring an image of a large area, such as when acquiring a full-face image of a patient, a full-jaw image, and so on. On the other hand, multispectral image acquisition is used when accurately measuring the color of one or two of the patient's teeth, in other words, when performing colorimetry of the teeth.

Colorimetry processing of a tooth using multispectral image acquisition, which is the main subject matter of the present invention, will be described below.

Multispectral Image Acquisition

First, the image-acquisition apparatus is lifted from the cradle 2 by a dentist, and a contact cap is attached to a mounting hole (not shown in the drawings) provided in the side of a case of the image-acquisition apparatus 1 from which light is emitted. This contact cap is made of a flexible material and has a substantially cylindrical shape.

Then, the image-acquisition mode is set to “colorimetry mode” by the dentist, whereupon the object is displayed as a moving image on the LCD 42. While looking at the image displayed on the LCD 42, the dentist positions the apparatus so that the vital tooth of the patient, which is the object to be measured, is disposed at a suitable position in the image-acquisition area and adjusts the focus using the focus lever 25. The contact cap is formed in a shape which guides the vital tooth to be measured to a suitable image-acquisition position, and therefore, it is possible to easily carry out this positioning.

Once positioning and focus adjustment have been completed, the dentist presses the shutter button 52, whereupon a signal to that effect is sent to the CPU 31 via the operating unit interface 36, and multispectral image-acquisition is executed under the control of the CPU 31.

In multispectral image acquisition, by sequentially driving the light sources 10a to 10g with the LED driver 32, LED radiation light of different wavelength bands is sequentially radiated onto the object. The reflected light from the object forms an image on the surface of the RGB image-acquisition device 22 in the image-acquisition unit 20, and is acquired as an RGB image. The acquired RGB image is sent to the signal processor 23. The signal processor 23 subjects the input RGB image signal to predetermined image processing and, from the RGB image signal, selects image data of one predetermined color in response to the wavelength bands of the light sources 10a to 10g. More specifically, the signal processor 23 selects the B image data from the image signal corresponding to the light sources 10a and 10b, selects the G image data from the image signal corresponding to the light sources 10c to 10e, and selects the R image data from the image signal corresponding to the light sources 10f and 10g. Therefore, the image-processing unit 23 selects image data of wavelengths which substantially match the central wavelengths of the illumination light.

The image data selected by the signal processor 23 is sent to the A/D converter 24 and is stored in the image memory 35 via the CPU 31. As a result, the color images selected from the RGB images corresponding to the central wavelengths of the LED are stored in the image memory 35 as multispectral images. During image acquisition, the LED radiation time and radiation intensity, the electronic shutter speed of the image-acquisition device, and so forth are controlled by the CPU 31 so that image acquisition of the respective wavelengths is performed with the proper exposure; if there is a severe temperature change during image acquisition, the alarm buzzer 65 emits an audible alarm.

Another image of the vital tooth is acquired without illuminating the LEDs and is stored in the image memory 35 as an external-light image.

Next, once image acquisition has been completed and the image-acquisition apparatus 1 is placed in the cradle 2 by the dentist, calibration image measurement is performed.

In calibration image measurement, an image of the color chart 100 is acquired using the same procedure as that used for the multispectral image acquisition described above. Accordingly, a multispectral image of the color chart 100 is stored in the image memory 35 as a color-chart image.

Next, image acquisition of the color chart 100 is carried out without illuminating any of the LEDs (under darkness), and this image is stored in the image memory 35 as a dark-current image. This dark-current image may be formed by performing image acquisition a plurality of times and averaging the images obtained.

Next, signal correction using the above-described external-light image and dark-current image stored in the image memory 35 is performed for the multispectral image and the color-chart image, respectively. The signal correction for the multispectral image is performed, for example, by subtracting a signal value of the external-light image data at each pixel from the image data of the multispectral image, which allows the effect of external light during image acquisition to be eliminated. Similarly, the signal correction for the color-chart image is carried out, for example, by subtracting a signal value of the dark-current image data at each pixel from the image data of the color-chart image, which allows dark-current noise (dark noise) in the CCD, which changes depending on temperature, to be removed.

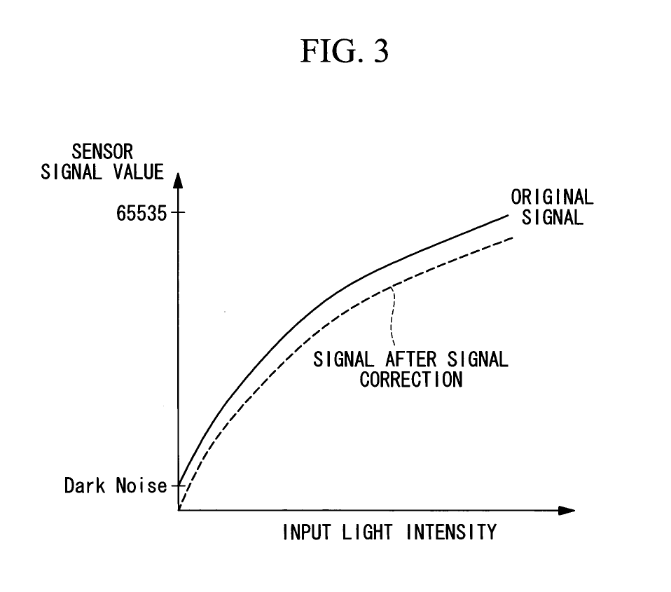

FIG. 3 shows an example of the signal correction results for the color-chart image. In FIG. 3, the vertical axis indicates the sensor signal value and the horizontal axis indicates the input light intensity. The solid line shows the original signal before correction and the dotted line shows the signal after correction.

After signal correction, the multispectral image and the color-chart image are sent to the dental colorimetry apparatus 3 via the local bus 37, the communication interface controller 34, and the communication interface connection point 61 and are stored in a multispectral image memory 110 in the dental colorimetry apparatus 3, as shown in FIG. 4.

In this case, the multispectral image and dark-current image of the above-described color chart 100 may be sent directly to the dental colorimetry apparatus 3 via the local bus 37, the communication interface controller 34, and the communication interface connection point 61, without being stored in the image memory 35 in the image-acquisition apparatus 1, and may be stored in the multispectral image memory 110 in the dental colorimetry apparatus 3. In such a case, the signal correction described above is carried out in the dental colorimetry apparatus 3.

The dental colorimetry apparatus 3 receives the multispectral image and the color-chart image output via the communication interface connection point 61 in the image-acquisition apparatus 1, and subjects the multispectral image to various types of processing. By doing so, it forms an image of the tooth (the object) which has a high degree of color reproducibility, selects an appropriate shade-guide number for the tooth, and displays this information on the display device 4.

As shown in FIG. 4, for example, the dental colorimetry apparatus 3 is formed of a chroma calculating unit 70, a shade-guide processing unit 80, the multispectral image memory 110, an RGB image memory 111, a color-image-generation processing unit 112, an image filing unit (first storage unit) 113, a shade-guide-information storage unit (second storage unit) 114, and an image-display GUI unit (display control unit) 115.

The chroma calculating unit 70 is formed of a spectrum-estimation computing unit 71, an observation-spectrum computing unit 72, and a chroma-value computing unit 73. The shade-guide processing unit 80 includes a shade-guide selection unit (region-specifying unit, measurement-area setting unit, and sample selection unit) 81 and a comparison processing unit 82. This comparison processing unit 82 is formed of a pixel extracting unit (first extracting unit and second extracting unit) 821 and an image-generating unit (first image-generating unit and second image-generating unit) 822.

This shade-guide-information storage unit 114 stores, for example, shade-guide acquired image data, in association with shade guide numbers, for each manufacturer producing shade guides in which color samples are arranged in rows; in addition, it also stores spectral curves (more specifically, spectral reflectance curves) for predetermined areas of these shade guides and shade guide images associated with the gums. The shade-guide-information storage unit 114 stores calorimetric information (for example, RGB values, L*a*b* values, CMYK values, XYZ values, Yuv values, L*C*h* values, and so on) obtained on the basis of the shade-guide acquired image data for each pixel of the acquired image data.

In the image processing apparatus 3 having such a configuration, the multispectral image and color-chart image sent from the image-acquisition apparatus 1 are first stored in the multispectral-image memory 110, and thereafter are sent to the chroma calculating unit 70. In the chroma calculating unit 70, first, spectrum (in this embodiment, a spectral reflectance curve) estimation processing and so forth are carried out by the spectrum-estimation computing unit 71.

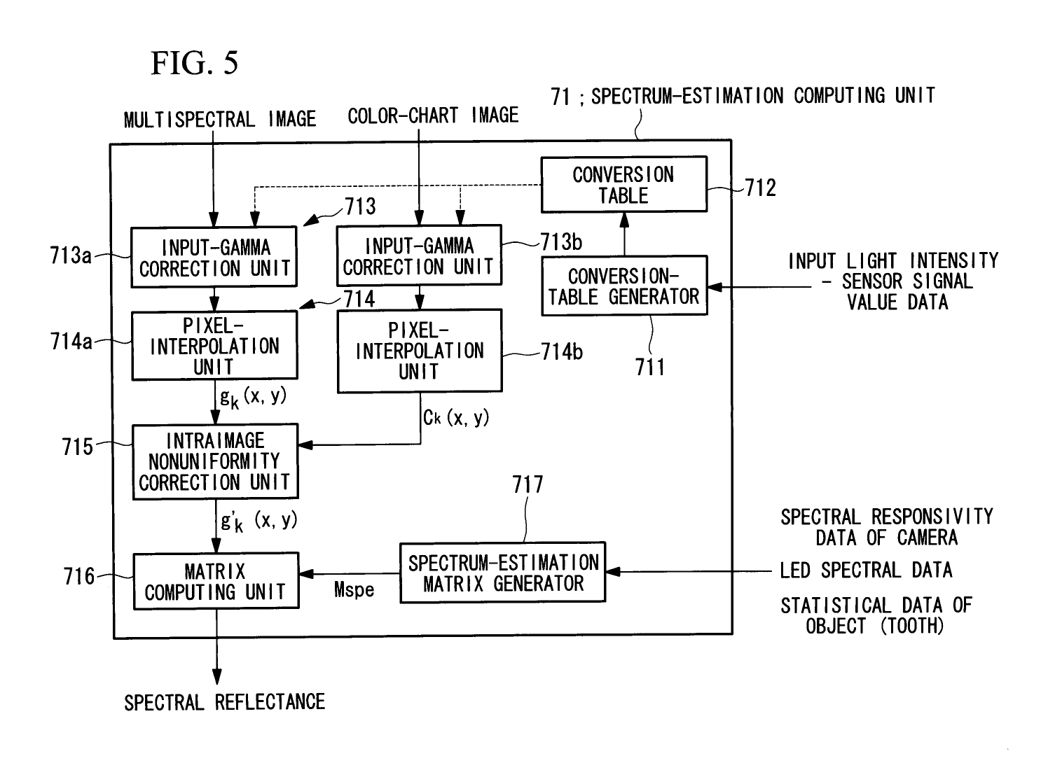

As shown in FIG. 5, the spectrum-estimation computing unit 71 is formed of a conversion-table generating unit 711, a conversion table 712, an input-gamma correction unit 713, a pixel-interpolation unit 714, an intraimage nonuniformity correction unit 715, a matrix computing unit 716, and a spectrum-estimation matrix generating unit 717. Separate input-gamma correction units 713 and pixel-interpolation units 714 are provided for the multispectral image and the color-chart image, respectively; that is, an input-gamma correction unit 713a and a pixel-interpolation unit 714a are provided for the multispectral image, and an input-gamma correction unit 713b and a pixel-interpolation unit 714b are provided for the color-chart image.

In the spectrum-estimation computing unit 71 having such a configuration, first the multispectral image and the color-chart image are sent to the separate input-gamma correction units 713a and 713b, respectively, and after input-gamma correction is performed, they are subjected to image interpolation processing by the corresponding pixel-interpolation units 714a and 714b. The signals obtained after this processing are sent to the intraimage nonuniformity correction unit 715, where intraimage nonuniformity correction processing is performed on the multispectral image using the color-chart image. Thereafter, the multispectral image is sent to the matrix computing unit 716, and the spectral reflectance is calculated using a matrix generated by the spectrum-estimation matrix generating unit 717.

The image processing carried out in each unit will be described more concretely below.

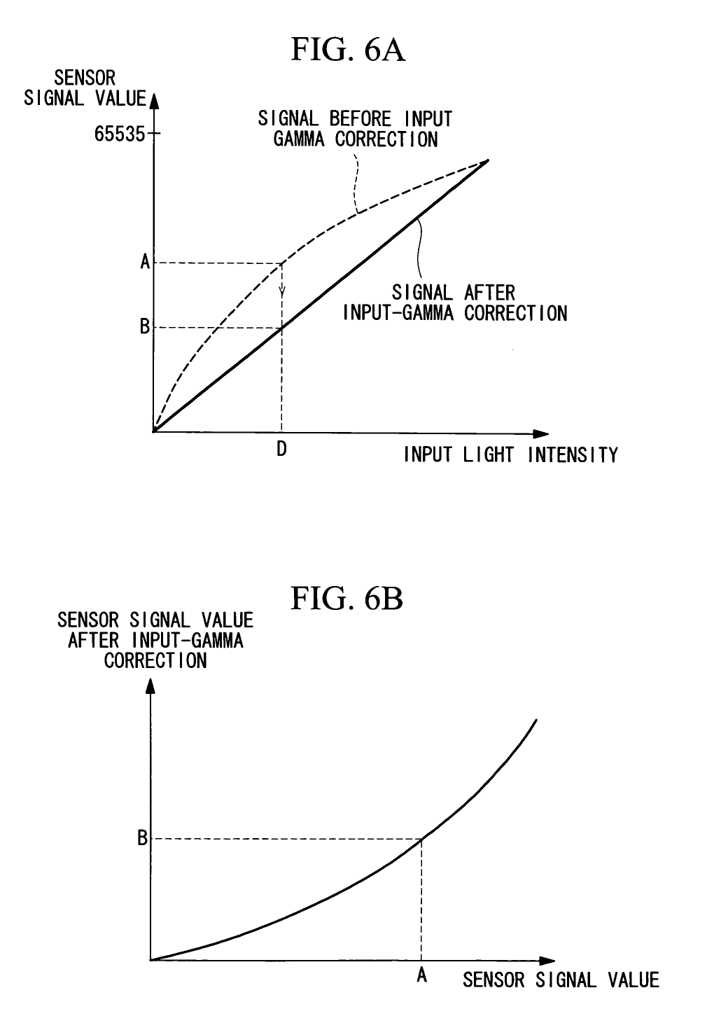

First, prior to input-gamma correction, the conversion table 712 is created by the conversion-table generating unit 711. More specifically, the conversion-table generating unit 711 contains data associating the input light intensity and the sensor signal value, and it creates the conversion table 712 based on this data. The conversion table 712 is created from the relationship between the input light intensity and the output signal value; as shown by the solid line in FIG. 6A for example, it is created such that the input light intensity and the sensor signal value are substantially proportional.

The input-gamma correction units 713a and 713b perform input-gamma correction on the multispectral image and the color-chart image, respectively, by referring to this conversion table 712. This conversion table 712 is created such that an input light intensity D corresponding to a current sensor value A is obtained and an output sensor value B corresponding to this input light intensity D is output; the result is shown in FIG. 6B. Accordingly, when input-gamma correction is performed on the multispectral image and the color-chart image, the corrected image data is sent to the pixel-interpolation units 714a and 714b, respectively.

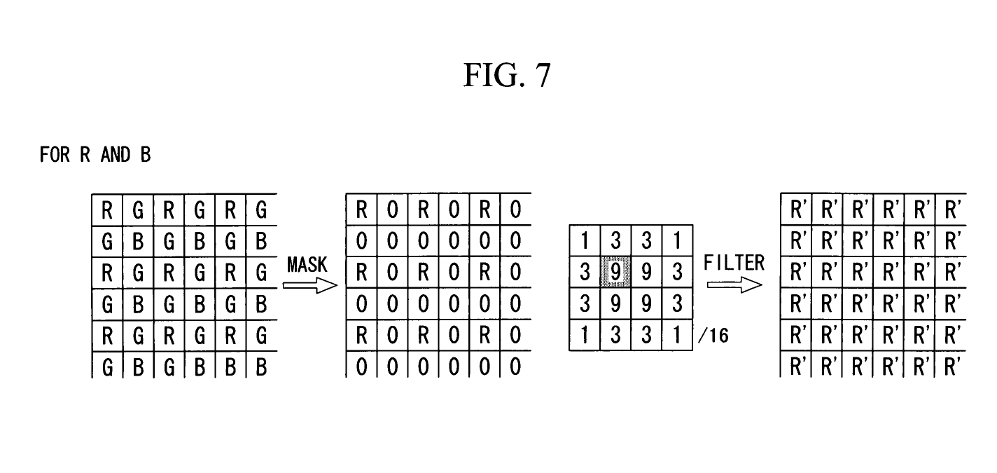

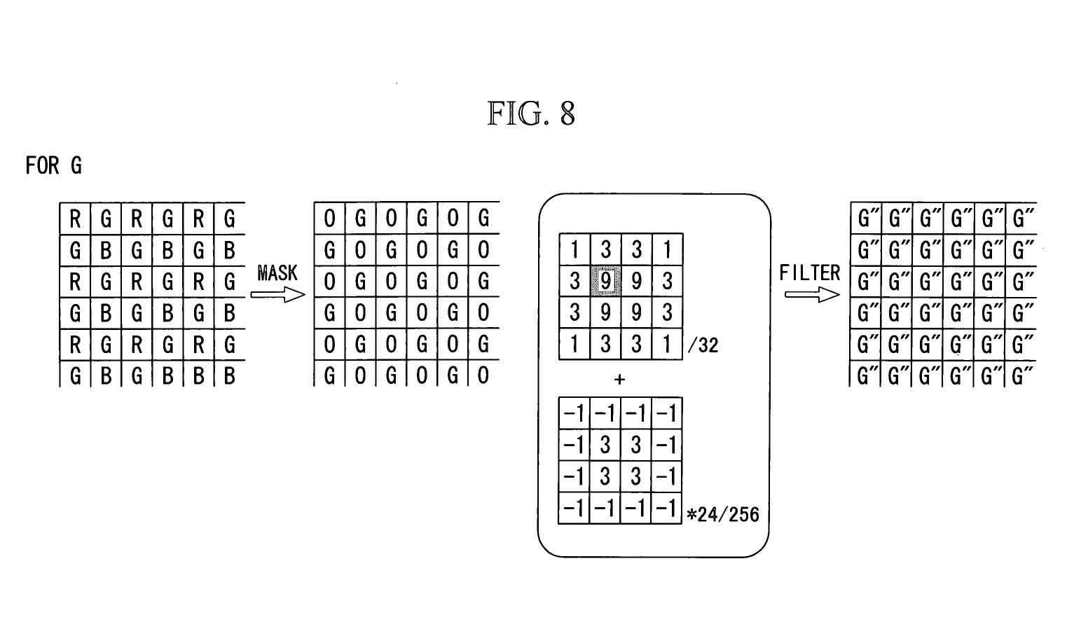

In the pixel-interpolation units 714a and 714b, pixel interpolation is performed by multiplying each of the multispectral image data and the color-chart image data, which have been subjected to input-gamma correction, by a low-pass filter for pixel interpolation. FIG. 7 shows an example of a low-pass filter applied to the R signal and the B signal. FIG. 8 shows a low-pass filter applied to the G signal. By multiplying each multispectral image data value by such low-pass filters for pixel interpolation, a 144×144 pixel image, for example, becomes a 288×288 pixel image.

Image data gₖ(x,y) which has been subjected to image interpolation is then sent to the intraimage nonuniformity correction unit 715.

The intraimage nonuniformity correction unit 715 corrects the luminance at the center of the screen of the multispectral image data using equation (1) below.

$${g}_{k}^{′} ( x , y ) = {g}_{k} ( x , y ) \frac{{\sum }_{η = {y}_{0} - δ / 2}^{{y}_{0} + δ / 2} {\sum }_{ξ = {x}_{0} - δ / 2}^{{x}_{0} + δ / 2} {c}_{k} ( ξ , η ) / {δ}^{2}}{{\sum }_{η = y - δ / 2}^{y + δ / 2} {\sum }_{ξ = x - δ / 2}^{x + δ / 2} {c}_{k} ( ξ , η ) / {δ}^{2}} \qquad ( 1 )$$

In equation (1), cₖ(x,y) is acquired image data of the color chart, gₖ(x,y) is the multispectral image data after input-gamma correction, (x₀,y₀) is the center pixel position, δ (=5) is the area averaging size, and g′ₖ(x,y) is the image data after intraimage nonuniformity correction (where k=1, . . . , N (the number of wavelength bands)).

The intraimage nonuniformity correction described above is performed on each data value of the multispectral image data.

The multispectral image data after intraimage nonuniformity correction, g′ₖ(x,y), is sent to the matrix computing unit 716. The matrix computing unit 716 performs spectrum (in this embodiment, spectral reflectance) estimation processing using the multispectral image data g′ₖ(x,y) from the intraimage nonuniformity correction unit 715. In this spectrum estimation processing, in the wavelength band from 380 nm to 780 nm, estimation of the spectral reflectance is performed in 1-nm intervals. That is, in this embodiment, 401-dimension spectral reflectance data is estimated.

Generally, in order to obtain spectral reflectance for each single wavelength, large, expensive spectrometers or the like are used. In this embodiment, however, because the subjects are limited to teeth, by using predetermined characteristics of those objects, the 401-dimensional spectral reflectance data can be estimated with a small number of bands.

More specifically, the 401-dimensional spectral signal is calculated by performing a matrix calculation using the multispectral image data g′ₖ(x,y) and a spectrum-estimation matrix Mₛₚₑ.

The spectrum-estimation matrix Mₛₚₑ described above is created in the spectrum-estimation matrix generating unit 717 based on spectral responsivity data of the camera, spectral data of the LEDs, and statistical data of the object (tooth). The creation of this spectrum-estimation matrix is not particularly limited; known methods in the literature may be used. One example is described in S. K. Park and F. O. Huck, “Estimation of spectral reflectance curves from multispectrum image data”, Applied Optics, Vol. 16, pp. 3107-3114 (1977).

The spectral responsivity data of the camera, the spectral data of the LEDs, the statistical data of the object (tooth), and so on are stored in advance in the image filing unit 113 shown in FIG. 4. If the spectral responsivity of the camera changes depending on the sensor position, position-dependent spectral responsivity data may be obtained, or appropriate correction may be performed on the data for the central position.

When the spectral reflectance is computed by the spectrum-estimation computing unit 71, the computation result is sent, together with the multispectral image data, to the shade-guide selection unit 81 in the shade-guide processing unit 80 and the observation-spectrum computing unit 72 and the chroma calculating unit 70, as shown in FIG. 4.

In the shade-guide selection unit 81 in the shade-guide processing unit 80, first, region-specifying processing for specifying a tooth region to be measured is carried out.

Here, information about the tooth to be measured, as well as information about the neighboring teeth, the gum, and so forth, is also included in the multispectral image data acquired by the image-acquisition apparatus 1. Therefore, processing for specifying the tooth region to be measured from this oral-cavity image data is carried out in the region-specifying processing.

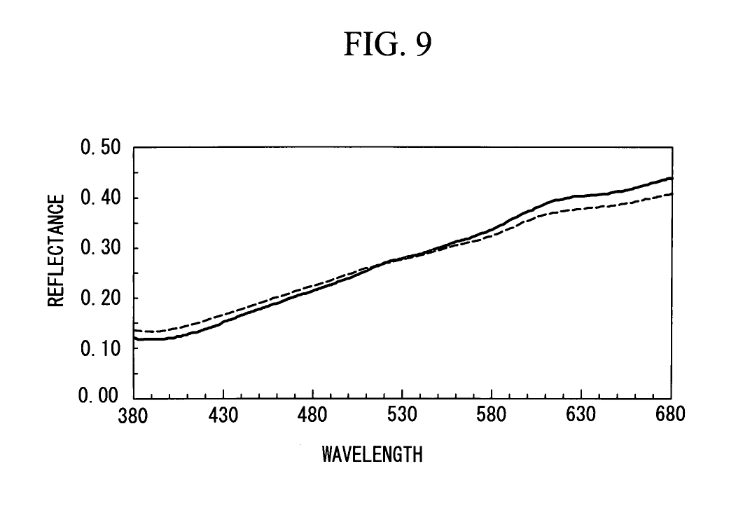

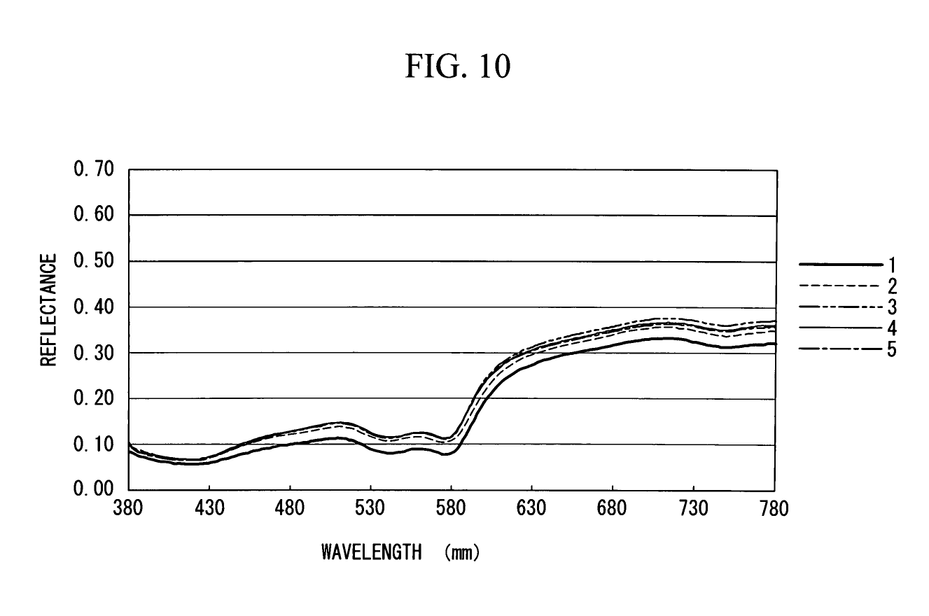

An example of the reflectance spectrum of the tooth (number of samples, n=2) is shown in FIG. 9, and an example of the reflectance spectrum of the gum (number of samples, n=5) is shown in FIG. 10. In FIGS. 9 and 10, the horizontal axis indicates wavelength and the vertical axis indicates reflectance. Because the tooth is completely white and the gum is red, there is a large difference between the two spectra in the blue wavelength band (for example, from 400 nm to 450 nm) and in the green wavelength band (for example, from 530 nm to 580 nm), as is clear from FIGS. 9 and 10. Thus, in this embodiment, noting that the tooth has a specific reflectance spectrum, the tooth region is specified by extracting from the image data pixels exhibiting this specific tooth reflectance spectrum.

Tooth-Region Specifying Method 1

In this method, in a region in the image represented by the acquired multispectral image data (a pixel or a group of pixels), wavelength-band characteristic values determined by respective signal values of n wavelength bands form an n-dimensional space. Thus, in this n-dimensional space, a plane representing the characteristic of the measured object is defined. When the wavelength-band characteristic values represented in the n-dimensional space are projected onto this plane, the region (outline) to be measured is specified by determining that the region in the image having that wavelength-band characteristic value is included in the tooth region to be measured.

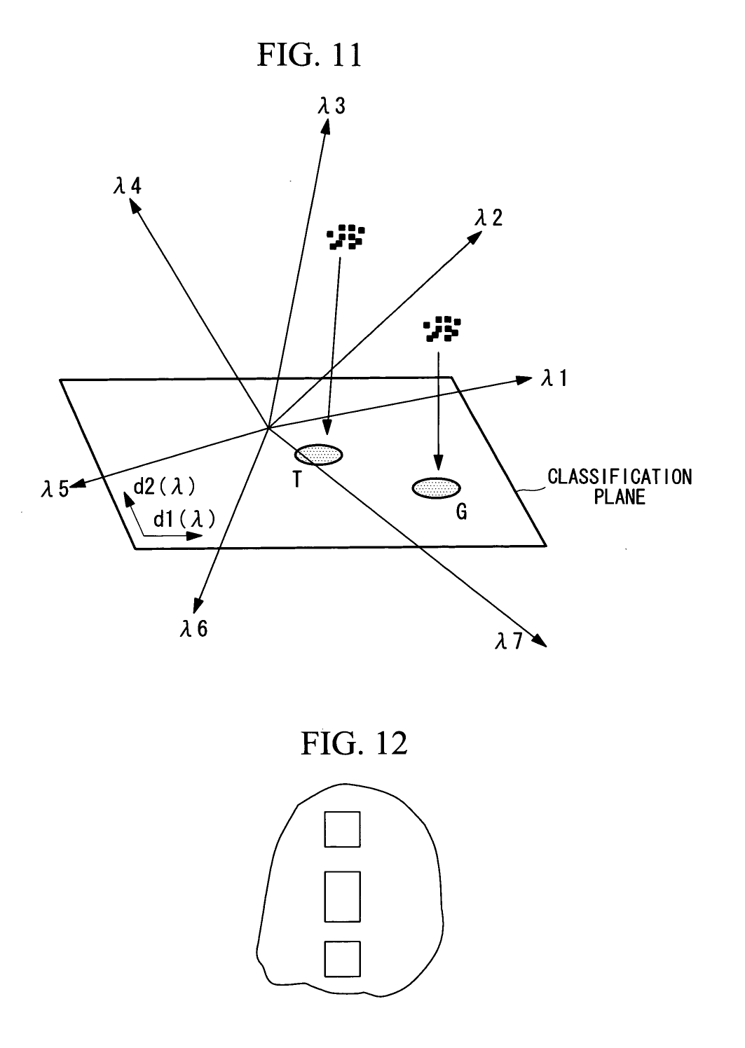

FIG. 11 illustrates the method for specifying the tooth region to be measured using this method. As shown in FIG. 11, a 7-dimensional space is formed by seven wavelengths λ1 to λ7. A classification plane for optimally separating the tooth to be measured is defined in the 7-dimensional space. More specifically, classification spectra d1(λ) and d2(λ) for plane projection are determined. Then, a predetermined region is first cut out from the acquired multispectral image data, and a feature value which is represented in the 7-dimensional space is computed as the wavelength-band characteristic value. The feature value is a combination of seven signal values obtained when each band in the cut-out region is averaged in this region and converted to seven signal values. The size of the cut-out region is, for example 2 pixels×2 pixels, but it is not limited to this size; it may be 1 pixel×1 pixel, or it may be 3 pixels×3 pixels or larger.

The feature value is represented by a single point in the 7-dimensional space in FIG. 11. The single point in the 7-dimensional space represented by this feature value is projected onto the classification plane to obtain one point on the classification plane. The coordinates of the point on the classification plane can be obtained from the inner product of the classification spectra d1(λ) and d2(λ). If the point on the classification plane is included in a region T on the classification plane, determined by the characteristic spectrum of the tooth, that is, in a planar region representing the characteristics of the measured object, the cut-out region is determined to be included within the outline of the tooth. On the other hand, if the point on the classification plane is included in a region G, determined by the characteristic spectrum of the gum, the cut-out region is determined to be included within the outline of the gum.

In this method, the tooth region is specified by sequentially carrying out this determination while changing the cut-out region. In particular, the tooth region to be measured is normally positioned close to the center of the image represented by the acquired multispectral image data. Therefore, the tooth region to be measured (in other words, the outline of the tooth to be measured) is specified by sequentially carrying out the above-described determination of whether or not the cut-out region is included in the tooth region while moving the cut-out region from the vicinity of the center of the image towards the periphery. In particular, this embodiment is advantageous in that it is possible to more accurately specify the region (outline) to be measured, because the feature value is defined in a 7-dimensional space, which has more dimensions than a 3-dimensional space formed by the standard RGB image.

Tooth-Region Specifying Method 2

In addition to the region specifying method based on the classification spectrum described above, this method specifies as the tooth region a region having a signal value (spectrum) that is unique to the tooth. This is achieved by extracting, for example, only signal values (spectra) corresponding to the blue wavelength band and the green wavelength band and comparing these signal values. According to this method, because the number of samples to compare is low, it is possible to easily carry out region specifying in a short period of time.

More concretely, similar to the case described above where region specifying is carried out based on the classification spectrum, by detecting the position of an inflection point where the spectral characteristic value changes suddenly, that position is determined to be the outline of the tooth to be measured. For example, an object to be detected (tooth) and an object to be separated (an object other than the tooth, such as the gum) are compared, characteristic bands λ1 and λ2 are selected, and the ratio thereof yields the spectral characteristic value. When the object to be detected is a tooth, the ratio of two points is calculated as, for example, λ1=450 nm and λ2=550 nm to obtain the inflexion point of that ratio. Accordingly, it is possible to determine the boundary with the neighboring tooth and to obtain pixels of the tooth to be measured. In addition to performing specifying for each pixel, it is also possible to take the average of pixel groups formed of a plurality of pixels and to perform specifying for each pixel group based on this average.

Whichever of the tooth-region specifying methods 1 and 2 described above is used, in this embodiment, region specifying is carried out for the tooth. However, it is also possible to carry out region specifying for the gum. In addition to the region specifying methods described above, for example, the tooth to be measured may be displayed on the display device 4 and the outline may be set by the user on the screen displayed on the display device 4.

Accordingly, once the pixels of the tooth to be measured are specified, next, measurement-region defining processing is carried out for defining measurement regions in the tooth region to be measured. As shown in FIG. 12, these measurement regions are defined as rectangular regions at the top (cervical area), middle (body), and bottom (incisal area) of the tooth surface. For example, regions having areas with fixed ratios with respect to their height on the tooth are defined. In other words, whether the tooth is large or small, the measurement regions and the positions thereof are defined with a constant ratio. The shapes of the measurement regions are not limited to the rectangular shapes shown in FIG. 12; for example, the shapes may be circular, elliptical, or asymmetric.

Next, shade-guide selection processing for selecting the closest shade guide is carried out for each measurement region defined as described above. In this shade-guide selection processing, the color of the tooth to be measured and the color of the shade guide are compared to determine whether they match. This comparison is carried out for each measurement region defined as described above; it is performed by comparing the spectrum (in this embodiment, the spectral reflectance) of the measurement region and the spectrum (in this embodiment, the spectral reflectance) of each shade guide stored in advance in the shade-guide-information storage unit 114 to determine the shade guide having the minimum difference between the two spectra.

Such shade guide selection processing is carried out, for example, by obtaining a spectrum-determining value (J value) based on equation (2) below.

$$Jvalue = C \sqrt{\frac{{\sum }_{λ} ( {( {f}_{1} ( λ ) - {f}_{2} ( λ ) )}^{2} {E ( λ )}^{2} )}{n}} \qquad ( 2 )$$

In equation (2), J value is the spectrum-determining value, C is a normalization coefficient, n is the sample number (number of wavelengths λ used in the calculation), λ is wavelength, f₁(λ) is the spectral reflectance curve of the tooth to be determined, f₂(λ) is the spectral reflectance curve of the shade guide, and E(λ) is a determination-responsivity correction curve. In this embodiment, weighting related to the spectral responsivity, which depends on the wavelength λ, is performed using E(λ).

Accordingly, the spectral curves of each shade guide are substituted for f₂(λ) in equation (2) above to calculate the respective spectrum-determining values, that is, the J values. The shade guide exhibiting the smallest spectrum-determining value, or J value, is determined to be the shade-guide number closest to the tooth. In this embodiment, a plurality of candidates (for example, three) are extracted in order of smallest spectrum-determining value, or J value. Of course, it is also possible for the number of candidates to be extracted to be one. The determination-responsivity correction curve E(λ) in equation (2) above may have various weights.

When a shade-guide number is selected as described above, the shade-guide selection unit 81 acquires chroma values (calorimetric information) L2*a2*b2* for each pixel of the selected shade guide and acquired image data from the shade-guide-information storage unit 114. The acquired chroma values L2*a2*b2*, the acquired image data, and the shade-guide number are output to the image-display GUI unit 115 and the comparison processing unit 82.

On the other hand, in the observation-spectrum computing unit 72 of the chroma calculating unit 70, the spectrum of the object under the illumination light used for observation is obtained by multiplying the illumination light spectrum S(λ) used for observation by the spectrum of the tooth obtained in the spectrum-estimation computing unit 71. S(λ) is the spectrum of the light source used for observing the color of the tooth, such as a D65 or D55 light source, a fluorescent light source, or the like. This data is stored in advance in the image-filing functional unit 112. The spectrum of the object under the illumination light used for observation, which is obtained in the observation-spectrum computing unit 72, is sent to the chroma-value computing unit 73.

In the chroma-value computing unit 73, L1*a1*b1* chromaticity values are calculated from the spectrum of the object under the illumination light used for observation, and, while the chroma values L1*a1*b1* for each pixel is output to the comparison processing unit 82 in the shade-guide processing unit 80, the chroma values associated with predetermined areas are averaged and sent to the image-display GUI unit 115.

These predetermined areas are defined, for example, at three positions at the top, middle, and bottom of the tooth.

On the other hand, a spectrum G(x,y,λ) of the object under the illumination light used for observation is sent to the color-image-generation processing unit 112, and RGB2(x,y), which is an RGB image for displaying on the monitor (acquired image data of the vital tooth), is created. The RGB image data of the vital tooth created by the color-image-generation processing unit 112 is output to the image-display GUI unit 115 and is transferred to the comparison processing unit 82 in the shade-guide processing unit 80. This RGB image data of the vital tooth is output to the image filing unit 113 and is stored therein. RGB image data having desired colors may be created by further subjecting the RGB image data to corrections such as edge enhancement, by the color-image-generation processing unit 112.

The chroma values L1*a1*b1* for each pixel of the vital tooth output from the chroma-value computing unit 73, the shade guide number selected by the shade-guide selection unit 81, the chroma values L2*a2*b2* of each pixel, and the acquired image data (RGB image data of the shade guide) are transferred to the pixel extracting unit 821 in the comparison processing unit 82.

Based on the chroma values L1*a1*b1* for each pixel of the vital tooth received from the chroma-value computing unit 73, the pixel extracting unit 821 (reference acquisition unit) acquires the chroma values of a pixel that is registered in advance as a reference pixel as default reference chroma values L3*a3*b3* (equivalent to “reference calorimetric information” of the present invention). According to this embodiment, the reference pixel is the center pixel of the image of the vital tooth. More specifically, when the image of the vital tooth is displayed in 288×288 pixels, the pixel at the center, i.e., the pixel at the coordinate (x,y)=(144, 144), is employed as the reference pixel. The reference pixel may be set at any coordinate and can be registered in advance by the user. The user can register the reference pixel by, for example, inputting specific coordinate values on a setting screen or indicating a desired pixel in the image of the tooth displayed on the setting screen with a mouse.

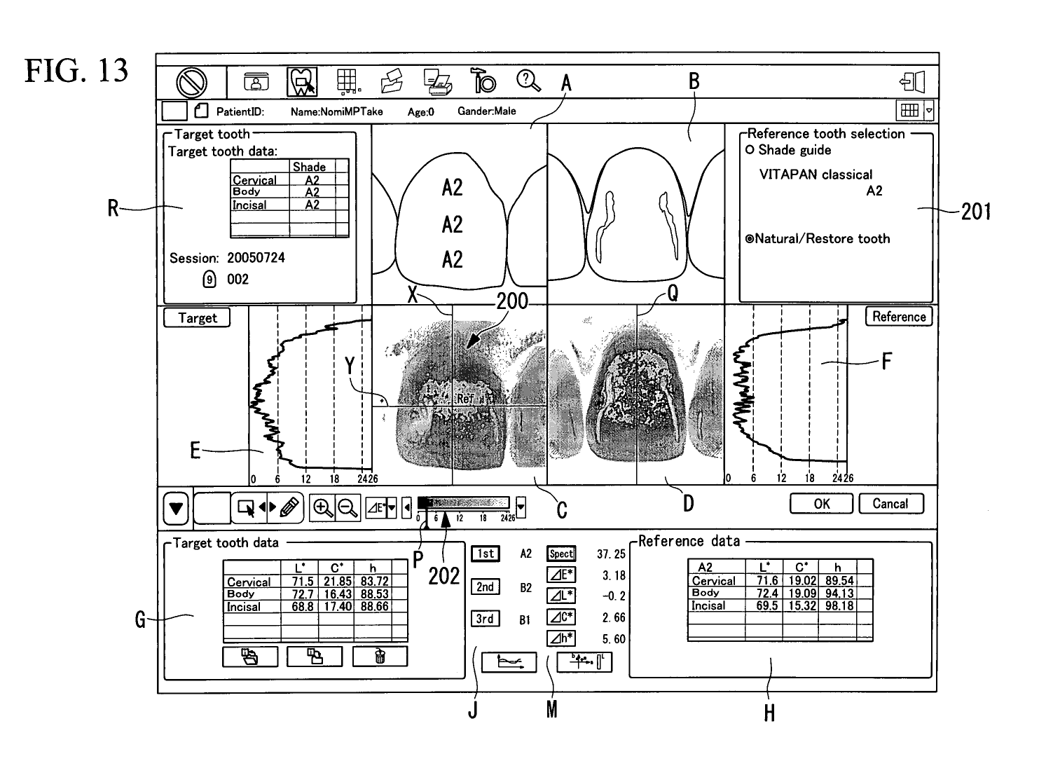

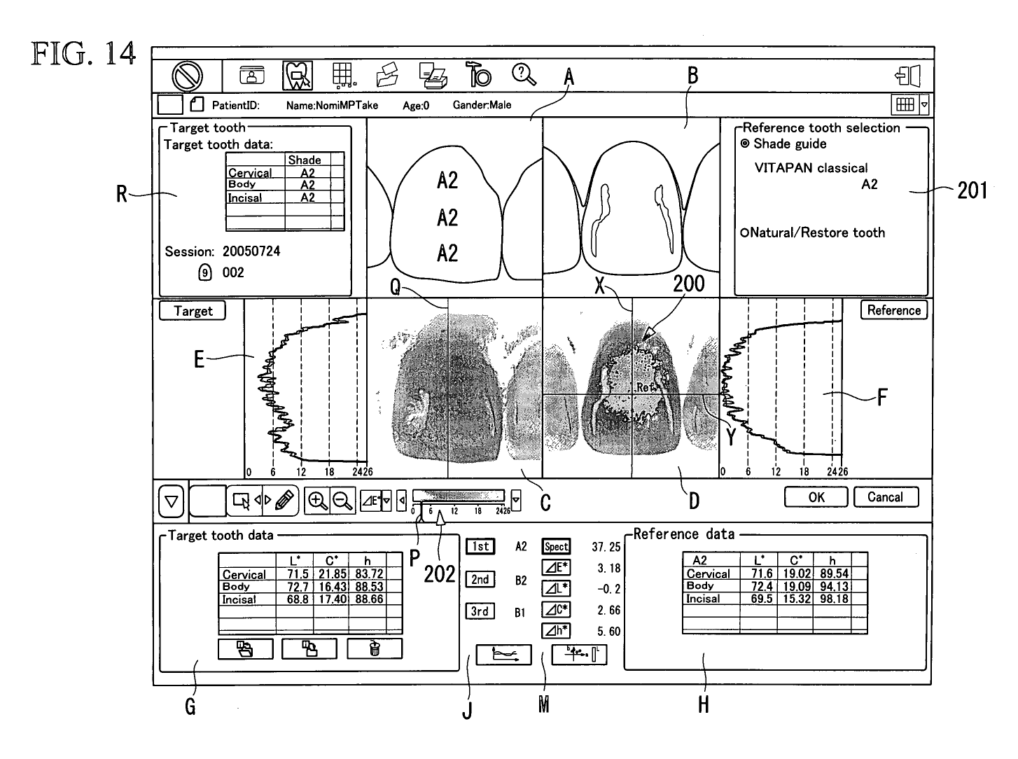

The reference pixel, i.e., reference chroma values, can be changed by a reference input section (reference input section) 200 that is described below and illustrated in FIGS. 13 and 14. The reference chroma values do not have to be acquired from an image of a vital tooth, as described above, but may be pre-registered as absolute values.

After acquiring the reference chroma values L3*a3*b3*, as described above, the pixel extracting unit 821 compares the chroma values L2*a2*b2* of each pixel of the shade guide and the reference chroma values L3*a3*b3*. More specifically, the pixel extracting unit 821 calculates a difference ΔE* between the chroma values L2*a2*b2* of each pixel of the shade guide and the reference chroma values L3*a3*b3*. Then, pixels whose difference ΔE* is smaller than a predetermined default threshold value, for example, pixels whose difference ΔE* is equal to or smaller than “3”, are extracted (hereinafter, a pixel group including these extracted pixels is referred to as a “third pixel group”).

The difference ΔE* can be obtained by the following equation (3).
ΔE*=√{(L3*−L2*)²+(a3*−a2*)²+(b3*−b2*)²} (3)

Similarly, the pixel extracting unit 821 calculates the difference ΔE* of the chroma values L1*a1*b1* and the reference chroma values L3*a3*b3* and extracts pixels whose difference ΔE* is smaller than a predetermined default threshold value, for example, pixels whose difference ΔE* is equal to or smaller than “3” (hereinafter, a pixel group including the extracted pixels is referred to as a “first pixel group”). In this way, after extracting pixels that satisfy a predetermined condition, the pixel extracting unit 821 outputs the coordinate information of the pixels included in the first and third pixel groups to the image-generating unit 822. The “predetermined condition” according to this embodiment is “the difference between a pixel and reference chroma values being smaller than or equal to a threshold value ‘3’”. The threshold value, difference ΔE*=3, for example, is equivalent to a boundary value representing that a dentist or a dental technician can objectively determine the color of the vital tooth as substantially matching the color of the shade guide. The threshold value, i.e., predetermined condition, can be changed by a condition input section 202 that is described below and illustrated in FIGS. 13 and 14.

After receiving the pixel coordinate information associated with the third pixel group and the pixel coordinate information associated with the first pixel group from the pixel extracting unit 821, the image-generating unit 822 employs the image-acquisition data of the shade guide for the pixels included in the third pixel group and creates sample comparison data represented by colors corresponding to the chroma values of the pixels not included in the third pixel group, i.e., pixels whose difference between the reference chroma values is greater than the threshold value “3” (hereinafter, these pixels are referred to as a “fourth pixel group”).

Similarly, the image-generating unit 822 employs the image-acquisition data of the vital tooth for the pixels included in the first pixel group and creates vital tooth comparison data represented by colors corresponding to the chroma values of the pixels not included in the first pixel group, i.e., pixels whose difference between the reference chroma values is greater than the threshold value “3” (hereinafter, these pixels are referred to as a “second pixel group”).

For example, when pixels that correspond to 0≦ΔE*≦3 are included in the first and third pixels groups, when pixels that correspond to 3<ΔE* are included in the second and fourth pixel groups, when target ranges in the second and fourth pixel groups correspond to 3<ΔE*<10, and when ranges outlying the target ranges correspond to 10≦ΔE*, the image-generating unit 822 represents each pixel included in the second and fourth pixel groups as shown below.

For example, the image-generating unit 822 defines pixels corresponding to ΔE*=0 as black and pixels corresponding to ΔE*=10 as white. The image-generating unit 822 represents pixels that correspond to 3<ΔE*<10 in gray, where the gray level increases as the value of ΔE* becomes larger, and represents all pixels that correspond to 10≦ΔE* in white.

More specifically, when pixels correspond to 3<ΔE*<10, the image-generating unit 822 represents the pixels in RGB values obtained by equations (4) below:
R=ΔE*×25.5
G=ΔE*×25.5
B=ΔE*×25.5 (4)

Accordingly, since the pixels within the range 0≦ΔE*≦3 are included in the first and third pixel groups, various image-acquisition data, for example, pixels included in a real image and corresponding to 0<ΔE*<3, is represented by a gray scale so that the change can be easily grasped visually, and all pixels that correspond to 10≦ΔE* are represented in white.

As another representation, when pixels that correspond to 0≦ΔE*<10 are included in the first and third pixel groups, when pixel that correspond to 10≦ΔE* are included in the second and fourth pixel groups, when target ranges in the second and fourth pixel groups correspond to 10≦ΔE*<24, and ranges outlying the target ranges correspond to 24≦ΔE*, the image-generating unit 822 represents each pixel included in the second and fourth pixel groups as shown below.

For example, the image-generating unit 822 defines pixels corresponding to ΔE*=0 as black and pixels corresponding to ΔE*=24 as white. The image-generating unit 822 represents pixels that correspond to 10<ΔE*<24 in gray, where the gray level increases as the value of ΔE* becomes larger, and represents all pixels that correspond to 24≦ΔE* in white.

More specifically, when a pixel corresponds to 10<ΔE*<24, the image-generating unit 822 represents the pixels in RGB values obtained by the equations (5) below:
R=ΔE*×10.625
G=ΔE*×10.625
B=ΔE*×10.625 (5)

Accordingly, similar to the above, since the pixels within 0≦ΔE*≦10 are included in the first and third pixel groups, various image-acquisition data, for example, pixels included in a real image and corresponding to 10<ΔE*<24, is represented by a gray scale so that the change can be easily grasped visually, and all pixels that correspond to 24≦ΔE* are represented in white.

The gray-scale representation described above may be changed to a dark and light representation using a halftone or mesh.

In equations 4 and 5, each coefficient multiplied by the color difference ΔE* is used to set the maximum value of ΔE* to 255. However, the maximum value of ΔE* is not limited to 255 and may be changed depending on the setting of the operating system (OS).

When the image-generating unit 822 creates the above-described sample comparison image and vital tooth comparison image, these images are output to the image-display GUI unit 115.

The image-display GUI unit 115 creates screen image data based on the sample comparison image, the vital tooth comparison image, the RGB image of the vital tooth, the RGB image of the shade guide, and the shade guide number, all obtained as described above, and displays a screen, such as that shown in FIG. 13, on the display screen of the display device 4.

As shown in FIG. 13, the image-display GUI unit 115 displays a color image A of the vital tooth, which is the object to be measured, in the upper central area of the display screen and displays a color image B of the shade guide on the right of the color image A. Below the color image of the vital tooth, a vital tooth comparison image C created at the image-generating unit 822 is displayed, and on the right of the vital tooth comparison image C, a sample comparison image D is displayed.

In the screen, the reference input section 200 for inputting the reference chroma values are provided on the vital tooth comparison image C. In this embodiment, the reference input section 200 includes a longitudinal scanning line Y movable up and down and a lateral scanning line X movable right and left. The intersection of the longitudinal scanning line Y and the lateral scanning line X is used as the reference pixel in the pixel extracting unit 821. Therefore, on the screen, the longitudinal scanning line Y and the lateral scanning line X are disposed at default positions such that the intersecting point of the lines matches the center pixel (x,y)=(144,144) of the vital tooth comparison image C.

Since the longitudinal scanning line Y and the lateral scanning line X can be freely moved by the user, the user can scan the longitudinal scanning line Y and the lateral scanning line X so as to change the reference pixel used by the pixel extracting unit 821. As a result, the reference chroma values can be changed.

The display screen of the image-display GUI unit 115 is provided with an image selection section 201 for selecting the comparison image on which the reference input section 200 is to be displayed. The reference input section 200 can be displayed on one of the comparison images (hereinafter, the vital tooth comparison image and the sample comparison image are collectively referred to as “comparison images”), whichever is selected by the user at the image selection section 201. In this way, reference chroma values can be selected at both the vital tooth comparison image and the sample comparison image. FIG. 14 illustrates an example screen when the sample comparison image C is selected using the image selection section 201. As shown in the drawing, the reference input section 200 is displayed on the sample comparison image D.

As shown in FIGS. 13 and 14, the image-display GUI unit 115 displays a reference line Q on the comparison screen on which the reference input section 200 is not displayed. In other words, for the case shown in FIG. 13, the image-display GUI unit 115 displays the reference line Q on the sample comparison image D. The reference line Q is represented as a longitudinal line (Y axis) movable right and left. Then, the differences ΔE* of the chroma values of the pixels on the reference line Q and the reference chroma values are displayed on the right of the sample comparison image D as a line graph F. At this time, by displaying the Y axis of the line graph F and the Y axis (lateral scanning line X) of the sample comparison image D such that their scales match, the user can very easily recognize the area (pixels) corresponding to a particular difference ΔE*.

As shown in FIG. 13, in the sample comparison image C on which the reference input section 200 is displayed, the lateral scanning line X of the reference input section 200 functions as the reference line Q. The differences ΔE* of the chroma values of pixels on the lateral scanning line X and the reference chroma values are displayed on the left of the sample comparison image C as a line graph E. In this case too, the scales of the Y axis of the line graph E and the Y axis (lateral scanning line X) of the sample comparison image C are matched and displayed.

Since, in FIG. 14, the reference input section 200 is displayed on the sample comparison image D, the line graph F following the lateral scanning line X of the reference input section 200 is displayed on the right of the sample comparison image D, and the line graph E following the reference line Q is displayed on the left of the sample comparison image C.

The image-display GUI unit 115 displays calorimetric information of each region of the vital tooth as a list G in the lower left area of the screen. More specifically, a list of the average values of luminance L*, color C*, and hue h is displayed as calorimetric information corresponding to each region of the vital tooth, i.e., the cervical region, the body region, and the incisal region of the tooth in this embodiment. Similarly, the image-display GUI unit 115 displays calorimetric information of these regions of the shade guide in the lower right area of the screen as a list H. More specifically, a list of the average values of calorimetric information L*, C*, and h is displayed as calorimetric information corresponding to each of the cervical, body, and incisal regions of the shade guide selected as having a color most similar to the vital tooth (in this embodiment, the shade guide corresponding to identification number A2).

The image-display GUI unit 115 displays three shade guide numbers that are selected by the shade-guide selection unit 81, as shown in FIG. 4, between the list G and the list H as shade guide candidates J in decreasing order of the spectrum-determining value (J value). Furthermore, average values M of the differences between the sets of calorimetric information of the vital tooth and the sets of calorimetric information of the shade guide are displayed for each shade guide. As the shade guide candidates J, a first candidate A2, a second candidate B2, and a third candidate B1 are displayed. In FIGS. 13 and 14, as the average values M of the differences of the sets of calorimetric information of the shade guide and the sets of calorimetric information of the vital tooth of the first candidate A2, the average value of the differences “spect” between the spectra, the average value of the differences ΔE* between the chromaticity values, the average value of the differences ΔL* between the luminance values, the average value of the differences ΔC* between the colors, and the average value of the differences Δh* between the hues are displayed.

The shade guide candidates J whose average values of the differences of calorimetric information are to be displayed can be arbitrarily selected. The user can switch the shade guide candidates J so as to switch the displayed difference information M of the calorimetric information for each shade guide.

The condition input section 202 for inputting the above-described “predetermined condition” is provided on the display screen of the image-display GUI unit 115. In this embodiment, the condition input section 202 represents the color difference ΔE* along the lateral axis and is provided with a bar P that is movable along this lateral axis. The user can move the bar P to a desired value so as to change the predetermined threshold value to be used in the pixel extracting unit 821 shown in FIG. 4. In FIGS. 13 and 14, the registered default threshold value “3” is set on the bar P.

The image-display GUI unit 115 displays the first candidate of the shade guide in each region of the vital tooth as a list R on the right of the color image of the vital tooth.

When the user operates the reference input section 200 on the above-described screen, the reference pixel, i.e., the reference chroma values, employed by the pixel extracting unit 821, shown in FIG. 4, is updated, and computation is carried out again based on the newly set chroma values. Then, a vital tooth comparison image and a sample comparison image based on the reference chroma values updated by the user are created at the image-generating unit 822, and the vital tooth comparison image C and the sample comparison image D, shown in FIGS. 13 and 14 are updated to new images. Similarly, when the user operates the condition input section 202, the pixel extracting unit 821 and the image-generating unit 822 carry out similar processes based on the newly input condition. In this way, the vital tooth comparison image C and the sample comparison image D, shown in FIGS. 13 and 14 are updated to new images.

As described above, in the dental colorimetry system according to this embodiment, the chroma values of each pixel obtained based on the acquired image of the vital tooth and the chroma values of each pixel obtained based on the acquired image of the tooth sample are compared with the reference chroma values for each pixel, and the difference ΔE* is calculated. In such a case, pixels that correspond to differences ΔE* equal to or smaller than the predetermined threshold value “3” are represented by the image-acquisition data, i.e., the color of the real tooth or the color of the tooth sample, whereas the pixels that correspond to differences ΔE* greater than the predetermined threshold value “3” are represented by a gray level corresponding to the color difference ΔE*. Then, the vital tooth comparison image C and the sample comparison image D represented in such a manner are displayed on the same screen.

In this way, the user can confirm the vital tooth comparison image C and the sample comparison image D displayed on the same screen so as to easily determine which region satisfies the condition and which region does not satisfy the condition. In particular, in this embodiment, since the threshold value is set to the boundary value “3” at which the color of the vital tooth and the color of the shade guide substantially match, the distribution of pixels having substantially the same color can be easily grasped.

For example, the user can easily confirm in the example screen shown in FIG. 13 that pixels whose differences ΔE* from the reference chroma values (the pixel in the center of vital tooth) are three or smaller are widely distributed in the central region of the vital tooth and are distributed sparsely in the entire central region of the shade guide.

Since acquired image data is employed for pixels whose differences ΔE* are three or smaller, slight color differences in the corresponding regions can be determined by comparing the colors. In addition, other regions where the acquired image data is not employed, i.e., pixels whose differences ΔE* is greater than three, are represented in gray scale, from black to white, corresponding to the differences ΔE*. Therefore, the user can easily compare the color of the vital tooth and the color of the shade guide by viewing the screen. As a result, the user can more easily determine which color should be added to match the color tone of the vital tooth, compared to conventional methods that only allow the user to carry out subjective evaluation of the shade guide image, which is the reference image. In this way, a crown having a color more similar to the vital tooth can be produced.

With the dental colorimetry system according to this embodiment, for pixels whose differences ΔE* of the chroma values are greater than three, the darkness of the gray level changes according to the differences ΔE* of the pixels. Therefore, the user can grasp the change of the differences ΔE* by means of the gray level.

FIGS. 13 and 14 illustrate an example screen displaying only one sample comparison image D. However, the present invention is not limited thereto, and a plurality of chroma values of a plurality of shade guides may be compared with the reference chroma values to create a plurality of sample comparison images corresponding to the chroma values of the plurality of shade guides. Then, the created sample comparison images may be displayed on the same screen.

By displaying a plurality of sample comparison images, a larger number of shade guides can be compared with the vital tooth. In this way, a shade guide having characteristics similar to those of the vital tooth can be selected efficiently.

In the above-described first embodiment, one pixel is set to define the reference chroma values. However, the invention is not limited thereto, and the reference pixel may be a region including a plurality of pixels, such as 2×2 pixels or 3×3 pixels. In this way, when a region including a plurality of pixels defines as the reference chroma values, the average values of the chroma values of the pixels included in the region may be set as the reference chroma values.

For the shade guide, instead of comparing the chroma values of each pixel with the reference chroma values, the average values of the chroma values of the region including a plurality of pixels can be compared with the reference chroma values. In the above-described embodiment, chroma values are used as calorimetric information. However, other types of calorimetric information may be employed in the same manner as described above.

According to the above-described first embodiment, for pixels whose differences ΔE* of the chroma values are greater than three, the differences ΔE* of the pixels are represented by changes in the gray level. However, instead of ΔE*, a dark and light representation may be employed by using the luminance L* value of the pixel (for example, the range of 0≦L*≦100). More specifically, pixels included in the second and fourth groups are represented by RGB values obtained by the following equations (6):
R=L*×25.5
G=L*×25.5
B=L*×25.5 (6)

According to this representation, L* can be represented in gray having a gradation from 0 to 255. The range of the luminance L* may be 40≦L*≦90 to match the characteristic of the vital tooth. In this case, when L*<40, the RGB values are set to zero. When L*>90, the RGB values are set to 255. When 40≦L*≦90, the RGB values are determined by the equations (7) below:
R=L*×2.833
G=L*×2.833
B=L*×2.833 (7)

According to the above-described first embodiment, shade guides having a reflectance spectral curve approximating the reflectance spectral curve of the vital tooth are selected as candidates, and sample comparison images are created for only the selected shade guides. Instead of this, however, sample comparison images may be created for all shade guides stored in the shade-guide-information storage unit 114. According to this aspect, since a shade guide having a reflectance spectrum most closely approximating the reflectance spectrum of the vital tooth not have to be selected, the shade-guide selection unit 81 will not be needed.

In addition to this mode, a shade guide specifying section for inputting the number of the shade guide the user desires to compare is provided on the screen. The sample comparison image can be created based on the shade guide identified by the shade guide number input at the shade guide specifying section.

According to the above-described first embodiment, the dental colorimetry apparatus 3 is based on the premise that the processing is carried out by hardware. However, the configuration is not limited thereto. For example, a configuration in which the processing is carried out by separate pieces of software may be employed. In such a case, the dental colorimetry apparatus 3 includes a CPU, a main storage device, such as a RAM, and a computer-readable recording medium that stores a program for realizing all or part of the processing. The CPU reads out the program stored on the storage medium and carries out processing of information and computation so as to carry out the same processing as the above-described dental colorimetry apparatus.

The computer-readable recording medium is a magnetic disk, a magneto-optical disk, a CD-ROM, a DVD-ROM, a semiconductor memory, or the like. The computer program may be distributed to a computer through a communication line, and the computer receiving the distributed computer program may execute the computer program.

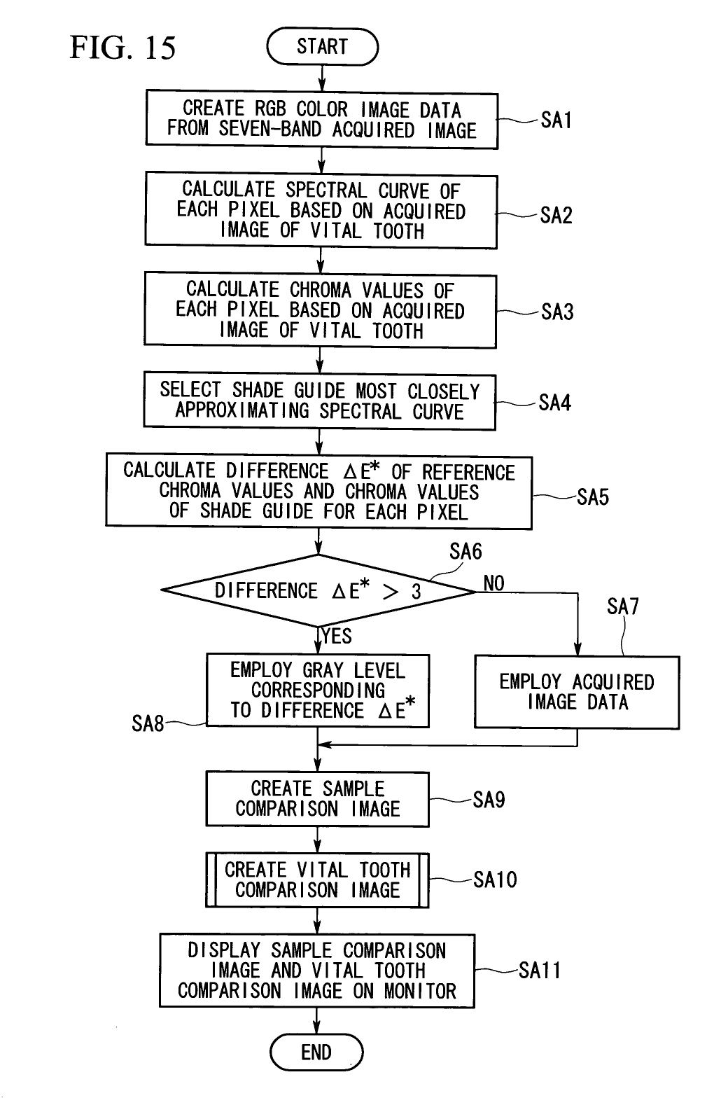

The steps of a dental colorimetry method carried out when the CPU executes the dental colorimetry program will be described below with reference to FIG. 15.

In Step SA1 in FIG. 15, a seven-band acquired image of a vital tooth is created from RGB color image data. Subsequently, in Step SA2, a spectral curve (more specifically, spectral reflectance curve) of each pixel is calculated based on the acquired image of the vital tooth. In Step SA3, chroma values are calculated based on the acquired image of the vital tooth. In Step SA4, the spectral curve calculated in Step SA2 is compared with the spectral curve of each shade guide stored in the shade-guide-information storage unit 114 so as to select a shade guide most closely approximating the reflectance spectral curve of the vital tooth is selected.

In the subsequent Step SA5, chroma values registered at the pixels are obtained from the shade-guide-information storage unit 114 as calorimetric information corresponding to the selected shade guide, and the difference ΔE* of selected chroma values and reference chroma values are calculated for each pixel. In Step SA6, it is determined whether or not the difference ΔE* for each pixel is equal to or smaller than “3”. When the difference ΔE* is three or smaller, the process proceeds to Step SA7, and the image-acquisition data of the corresponding shade guide is employed for the corresponding pixel. In contrast, when the difference ΔE* is greater than three, the process proceeds to Step SA8, and a gray level corresponding to the chroma values are employed. More specifically, a value obtained by multiplying the RGB values with [difference ΔE*×25.5] is employed. Then by carrying out this determination for all pixels, a sample comparison image is created in Step SA9. Subsequently, in Step SA10, the chroma values of each pixel for the vital tooth are compared with the reference chroma values, and a vital tooth comparison image is created by the same method. Then, in Step SA11, the created sample comparison image and the vital tooth comparison image are displayed on the monitor (display device) 4.

### Second Embodiment

Next, a dental colorimetry system according to a second embodiment of the present invention will be described.

In the first embodiment described above, chroma values are used as calorimetric information, and a sample comparison image and a vital tooth comparison image are created on the basis of the differences ΔE between the chroma values and the reference chroma values. However, in this embodiment, a spectral curve (more specifically, spectral reflectance curve) is used as calorimetric information, and a sample comparison image and a vital tooth comparison image are created on the basis of a difference Δspect between the spectral curve and a reference spectral curve.

The dental colorimetry system according to this embodiment will be described below, where descriptions of components that are the same as those in the first embodiment described above are omitted and descriptions of only the components that differ are provided.

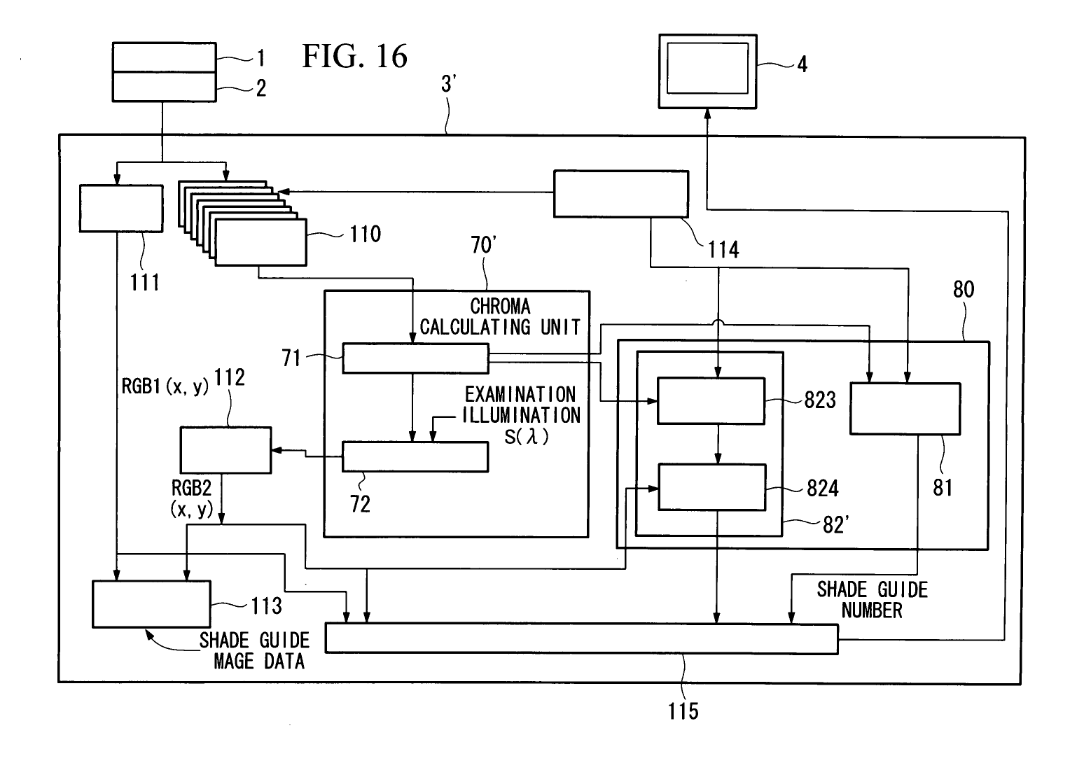

FIG. 16 illustrates, in outline, the configuration of the dental colorimetry apparatus according to this embodiment. Since the dental colorimetry apparatus according to this embodiment creates a sample comparison image on the basis of the spectral curve, the chroma-value computing unit 73 (refer to FIG. 4) for calculating chroma values is not required. As shown in FIG. 16, a spectral curve f₁(λ) that is calculated at a spectrum-estimation computing unit 71 is transferred to a shade-guide selection unit 81 and a comparison processing unit 82′ in a shade-guide processing unit 80. At the shade-guide selection unit 81, a shade guide that has a characteristic most closely approximating that of a vital tooth is selected on the basis of the spectral curve f₁(λ) acquired from the spectrum-estimation computing unit 71. Then, the shade guide number of the selected shade guide is output to an image-display GUI unit 115 and a pixel extracting unit 823 in the comparison processing unit 82′.

The pixel extracting unit 823 acquires a spectral curve f₃(λ) of a reference pixel (hereinafter referred to as the “reference spectral curve f₃(λ)”) from the spectral curves f₁(λ) of the pixels of the vital tooth acquired from the spectrum-estimation computing unit 71 and receives, from a shade-guide-information storage unit 114, spectral curves f₂(λ) of pixels of the shade guide that is identified by the shade guide number sent from the shade-guide selection unit 81. Then, the pixel extracting unit 823 compares the spectral curve f₂(λ) for each pixel with the reference spectral curve f₃(λ) and determines the difference Δspect. Subsequently, the pixel extracting unit 823 extracts pixels whose difference Δspect is equal to or smaller than a registered predetermined threshold value, for example, 4000 (hereinafter the pixel group including the pixels extracted here is referred to as a “third pixel group”).

Similarly, the pixel extracting unit 823 compares the spectral curve f₁(λ) for each pixel of the vital tooth and the reference spectral curve f₃(λ) to calculate the difference Δspect. Subsequently, the pixel extracting unit 823 extracts pixels whose difference Δspect is equal to or smaller than a registered predetermined threshold value, for example, 4000 (hereinafter the pixel group including the pixels extracted here is referred to as a “first pixel group”). In this way, after extracting pixels satisfying a predetermined condition, the pixel extracting unit 823 outputs coordinate information corresponding to the first and third pixel groups to an image-generating unit 824. The “predetermined condition” according to this embodiment is the difference with respect to the reference spectral curve being equal to or smaller than a threshold value of 4000.

After receiving the pixel coordinate information associated with the third pixel group and the pixel coordinate information associated with the first pixel group from the pixel extracting unit 823, the image-generating unit 824 employs image-acquisition data of the shade guide for the pixels included in the third pixel group and creates sample comparison data represented by colors corresponding to the spectral curves of the pixels not included in the third pixel group, i.e., pixels whose difference with respect to the reference spectral curve is greater than the threshold value of 4000 (hereinafter, these pixels are referred to as a “fourth pixel group”).

Similarly, the image-generating unit 824 employs image-acquisition data of the vital tooth for the pixels included in the first pixel group and creates vital tooth comparison data represented by colors corresponding to the spectral curves of the pixels not included in the first pixel group, i.e., pixels whose difference with respect to the reference spectral curve is greater than the threshold value of 4000 (hereinafter, these pixels are referred to as a “second pixel group”). The representation method of the second and fourth pixel groups is the same as that according to the first embodiment described above.

After creating the sample comparison image and the vital tooth comparison image, as described above, the image-generating unit 824 outputs these images to the image-display GUI unit 115.

The image-display GUI unit 115 displays the sample comparison image and the vital tooth comparison image on the display device 4. In this way, the vital tooth comparison image created by the image-generating unit 824 as an image C and the sample comparison image created by the image-generating unit 824 as an image D are displayed on a screen, in a manner such as that shown in FIGS. 13 and 14, on the display device 4.

As described above, according to the dental colorimetry system according to this embodiment, since the shade guide and the vital tooth are compared on the basis of spectral curves, the chroma-value computing unit 73 included in the dental colorimetry apparatus according to the first embodiment, illustrated in FIG. 4, is not required, and thus, the size of the apparatus and the processing load can be reduced.

For a dental colorimetry apparatus 3′ according to the second embodiment of the present invention, similar to the dental colorimetry apparatus 3 according to the above-described first embodiment, a configuration in which processing is carried out by software may be employed.

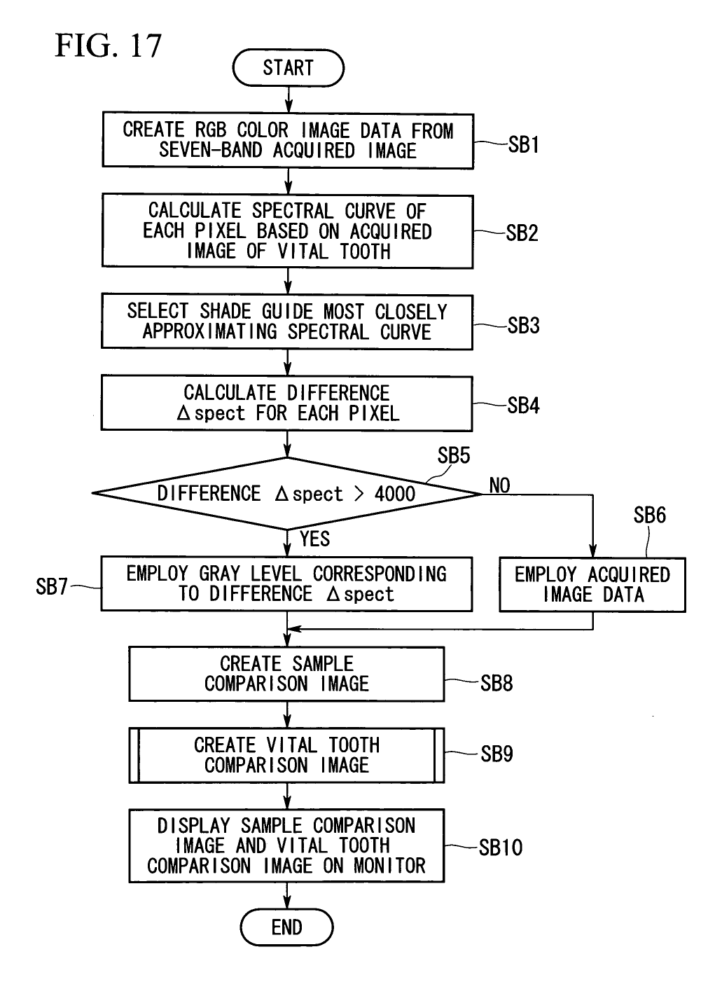

The steps of a dental colorimetry method carried out when the CPU executes a dental colorimetry program according to this embodiment will be described below with reference to FIG. 17.

In Step SB1 in FIG. 17, a seven-band acquired image of a vital tooth is created from RGB color image data. Subsequently, in Step SB2, a spectral curve (more specifically, a spectral reflectance curve) of each pixel is calculated on the basis of the acquired image of the vital tooth. In Step SB3, the spectral curve calculated in Step SB2 is compared with the spectral curve of each shade guide stored in the shade-guide-information storage unit 114 so as to select a shade guide most closely approximating the spectral curve. In Step SB4, registered spectral curves associated with the pixels are obtained from the shade-guide-information storage unit 114 as calorimetric information corresponding to the selected shade guide, and the difference Δspect between a selected spectral curve and the reference spectral curve is calculated for each pixel.

As a method of calculating the difference Δspect, one of the following equations 8 to 11 may be employed:

$$\begin{matrix}Δ spect = {\int }_{380}^{780} \vert {f}_{1} ( λ ) - {f}_{2} ( λ ) \vert ⅆ λ & ( 8 ) \\ Δ spect = {\int }_{380}^{780} {\{ {f}_{1} ( λ ) - {f}_{2} ( λ ) \}}^{2} ⅆ λ & ( 9 ) \\ Δ spect = {\sum }_{n = 380}^{780} \vert {f}_{1 n} ( λ ) - {f}_{2 n} ( λ ) \vert & ( 10 ) \\ Δ spect = {\sum }_{n = 380}^{780} {( {f}_{1 n} ( λ ) - {f}_{2 n} ( λ ) )}^{2} & ( 11 )\end{matrix}$$

In Step SB5, it is determined whether or not the difference Δspect for each pixel is equal to or smaller than 4000. When the difference Δspect is 4000 or smaller, the process proceeds to Step SB6, and the image-acquisition data of the corresponding shade guide is employed for the corresponding pixel. In contrast, when the difference Δspect is greater than 4000, the process proceeds to Step SB7, and a gray level corresponding to the difference Δspect is employed. Then by carrying out this determination for all pixels, a sample comparison image is created in Step SB8. Subsequently, in Step SB9, the spectral curve of each pixel for the vital tooth is compared with the reference spectral curve, and a vital tooth comparison image is created by the same method. Then, in Step SB10, the created sample comparison image and the vital tooth comparison image are displayed on the display device 4.

### Third Embodiment

Next, a third embodiment of the present invention will be described below. A feature of the dental colorimetry system according to this embodiment is that it has functions of the dental colorimetry apparatuses according to both the first and second embodiments described above. Therefore, in the dental colorimetry apparatus according to this embodiment, a comparative image can be created on the basis of chroma values or on the basis of spectral curves.

According to the above-described first to third embodiments, as reference chroma values or a reference spectral curve, chroma values or a spectral curve of a pixel in a vital tooth or a shade guide is employed. However, the present invention is not limited thereto, and, for example, the user may manually input reference chroma values or a reference spectral curve on a screen, such as that illustrated in FIG. 13 or 14.

According to the above-described embodiments, chroma values or a spectral curve is used as reference calorimetric information. However, the information is not limited thereto, and, for example, color temperature may be employed.

In the above-described embodiments, pixels included in the first and third pixel groups are represented by acquired image data, and pixels included in the second and fourth pixel groups are represented by a gray level corresponding to the comparison result with the reference colorimetric information. However, the representation methods of the pixels according to the image-generating units 822 and 824 are not limited to the above-described examples. In other words, it is acceptable so long as the sample comparison image is represented in a way that allows the third and fourth pixel groups to be visually distinguished and so long as the vital tooth comparison image is represented in a way that allows the first and second pixel groups to be visually distinguished.

For example, for the first and third pixel groups, in addition to employing the acquired image data, these groups may be represented by colors different from the colors representing the second and fourth pixel groups. In this case, the first and third pixel groups may be represented in a predetermined color (for example, red or orange) with a darkness corresponding to the comparison results of the colorimetric information and the reference calorimetric information, in a manner similar to that of the above-described second and fourth pixel groups. This aspect is not limited to changing the darkness of a color; instead, for example, the brightness may be changed. In other words, it is preferable that the representation mode reflect the differences with respect to the reference calorimetric information, and more preferably, that the change in the differences be represented by a gradation. In the above-described first to third embodiments, acquired image data is employed for the pixels included in the first and third pixel groups. However, in contrast, acquired image data may be employed for pixels included in the second and fourth pixel groups, and the pixels in the first and third pixel groups may be represented by varying gray levels corresponding to the differences.

What is claimed is:

1. A dental colorimetry apparatus comprising:
a first storage unit configured to store, for each pixel, acquired image data of a vital tooth and calorimetric information that is acquired on the basis of the acquired image data;
a reference acquisition unit configured to acquire reference colorimetric information that is used as a reference when comparing the calorimetric information;
a first extracting unit configured to compare the reference calorimetric information and the calorimetric information of each pixel of the vital tooth and to extract pixels whose comparison result satisfies a predetermined condition;
a first image-generating unit configured to create a vital tooth comparison image representing, in different colors, a first pixel group including pixels extracted by the first extracting unit and a second pixel group including pixels that are not extracted; and
a display control unit configured to display the vital tooth comparison image created by the first image-generating unit.

2. The dental colorimetry apparatus according to claim 1, further comprising:
a second storage unit configured to store, for each pixel, acquired image data of a tooth sample and calorimetric information that is acquired on the basis of the acquired image data;
a second extraction unit configured to compare the reference colorimetric information and the calorimetric information of each pixel of the tooth sample and to extract pixels whose comparison result satisfies a predetermined condition; and
a second image-generating unit configured to create a sample comparison image representing, in different colors, a third pixel group including pixels extracted by the second extracting unit and a fourth pixel group including pixels that are not extracted,
wherein the display control unit displays the sample comparison image created by the second image-generating unit and the vital tooth comparison image.

3. The dental colorimetry apparatus according to claim 2, wherein in the sample comparison image and the vital tooth comparison image, the first pixel group and the third pixel group are represented by the same color tone and the second pixel group and the fourth pixel group are represented by the same color tone.

4. The dental colorimetry apparatus according to claim 2,
wherein the first image-generating unit changes at least one of the brightness, chromaticity, and hue of each pixel in the vital tooth comparison image according to the calorimetric information of each pixel, and
wherein the second image-generating unit changes at least one of the brightness, chromaticity, and hue of each pixel in the sample comparison image according to the calorimetric information of each pixel.

5. The dental colorimetry apparatus according to claim 2,
wherein in the vital tooth comparison image created by the first image-generating unit, the pixels included in the first pixel group are represented by the acquired image data of the vital tooth, and
wherein in the sample comparison image created by the second image-generating unit, the pixels included in the third pixel group are represented by the acquired image data of the tooth sample.

6. The dental colorimetry apparatus according to claim 5,
wherein the first image-generating unit changes at least one of brightness, chromaticity, and hue of each pixel included in the second image group of the vital tooth comparison image according to the calorimetric information of each pixel, and
wherein the second image-generating unit changes at least one of the brightness, chromaticity, and hue of each pixel included in the fourth image group of the sample comparison image according to the calorimetric information of each pixel.

7. The dental colorimetry apparatus according to claim 1, wherein the display control unit displays a reference input section for inputting the reference calorimetric information on a screen displaying the vital tooth comparison image.

8. The dental colorimetry apparatus according to claim 1, wherein the display control unit displays a condition input section for inputting the predetermined condition on a screen displaying the vital tooth comparison image.

9. The dental colorimetry apparatus according to claim 2, further comprising:
a region-specifying unit configured to specify a region on a vital tooth to be measured, the region included in an acquired image of the oral cavity acquired by an image acquisition apparatus;
a measurement-region setting unit configured to define at least one measurement region in the specified region of the vital tooth; and
a sample selecting unit configured to select at least one tooth sample approximating a spectrum of the measurement region from a plurality of tooth samples registered in advance,
wherein the second extracting unit compares, for each pixel, the reference colorimetric information and calorimetric information of the tooth sample selected by the sample selecting unit.

10. A dental colorimetry system comprising:
an image-acquisition apparatus configured to acquire an image of an oral cavity;
a dental colorimetry apparatus configured to process the image acquired by the image-acquisition apparatus; and
a display device configured to display an image processed by the dental colorimetry apparatus,
wherein the dental colorimetry apparatus includes
a first storage unit configured to store, for each pixel, acquired image data of a vital tooth and colorimetric information that is acquired on the basis of the acquired image data,
a reference acquisition unit configured to acquire reference calorimetric information that is used as a reference when comparing the calorimetric information,
a first extracting unit configured to compare the reference calorimetric information and the calorimetric information of each pixel of the vital tooth and to extract pixels whose comparison result satisfies a predetermined condition,
a first image-generating unit configured to create a vital tooth comparison image representing, in different colors, a first pixel group including pixels extracted by the first extracting unit and a second pixel group including pixels that are not extracted, and
a display control unit configured to display the vital tooth comparison image created by the first image-generating unit.

11. The dental colorimetry system according to claim 10,
wherein the dental colorimetry apparatus further includes
a second storage unit configured to store, for each pixel, acquired image data of a tooth sample and colorimetric information that is acquired on the basis of the acquired image data,
a second extraction unit configured to compare the reference calorimetric information and the calorimetric information of each pixel of the tooth sample and to extract pixels whose comparison result satisfies a predetermined condition, and
a second image-generating unit configured to create a sample comparison image representing, in different colors, a third pixel group including pixels extracted by the second extracting unit and a fourth pixel group including pixels that are not extracted,
wherein the display control unit displays the sample comparison image created by the second image-generating unit and the vital tooth comparison image.

12. A dental colorimetry method comprising:
a reference acquiring step for acquiring reference colorimetric information that is used as a reference when comparing the calorimetric information that is acquired on the basis of the acquired image data of a vital tooth;
a first extraction step for comparing the calorimetric information of each pixel of the vital tooth and the reference calorimetric information and extracting pixels whose comparison result satisfies a predetermined condition;
a first image-generation step for creating a vital tooth comparison image representing, in different colors, a first pixel group including pixels extracted by the first extraction step and a second pixel group including pixels that are not extracted; and
a display control step for displaying the vital tooth comparison image.

13. The dental calorimetry method according to claim 12, further comprising:
a second extraction step for comparing the calorimetric information of each pixel, the calorimetric information having been acquired on the basis of the acquired image data of a tooth sample, and the reference calorimetric information and extracting pixels whose comparison result satisfies a predetermined condition; and
a second image-generation step for creating a sample comparison image representing, in different colors, a third pixel group including pixels extracted by the second extraction step and a fourth pixel group including pixels that are not extracted,
wherein the sample comparison image and the vital tooth comparison image are displayed in the display control step.

14. A dental calorimetry program to be executed by a computer, the program comprising:
reference acquiring processing for acquiring reference calorimetric information that is used as a reference when comparing the calorimetric information that is acquired on the basis of the acquired image data of a vital tooth;
first extraction processing for comparing the calorimetric information of each pixel of the vital tooth and the reference calorimetric information and extracting pixels whose comparison result satisfies a predetermined condition;
first image-generation processing for creating a vital tooth comparison image representing, in different colors, a first pixel group including pixels extracted by the first extraction processing and a second pixel group including pixels that are not extracted; and
display control processing for displaying the vital tooth comparison image.

15. The dental colorimetry program according to claim 14, further comprising:
second extraction processing for comparing the calorimetric information of each pixel, the calorimetric information having been acquired on the basis of the acquired image data of a tooth sample, and the reference calorimetric information and extracting pixels whose comparison result satisfies a predetermined condition; and
second image-generation processing for creating a sample comparison image representing, in different colors, a third pixel group including pixels extracted by the second extraction processing and a fourth pixel group including pixels that are not extracted,
wherein the sample comparison image and the vital tooth comparison image are displayed in the display control processing.

16. The dental colorimetry program according to claim 15 wherein in the sample comparison image and the vital tooth comparison image, the first pixel group and the third pixel group are represented by the same color and the second pixel group and the fourth pixel group are represented by the same color.

17. The dental colorimetry program according to claim 15,
wherein in the first image generation processing, at least one of the brightness, chromaticity, and hue of each pixel in the vital tooth comparison image is changed according to the calorimetric information of each pixel, and
wherein in the second image generation processing, at least one of the brightness, chromaticity, and hue of each pixel in the sample comparison image is changed according to the calorimetric information of each pixel.

18. The dental colorimetry program according to claim 15,
wherein, in the vital tooth comparison image created in the first image generation processing, the pixels included in the first pixel group are represented by the acquired image data of the vital tooth, and
wherein in the sample comparison image created in the second image generation processing, the pixels included in the third pixel group are represented by the acquired image data of the tooth sample.

19. The dental colorimetry program according to claim 18,
wherein in the first image generation processing, at least one of the brightness, chromaticity, and hue of each pixel included in the second image group of the vital tooth comparison image is changed according to the calorimetric information of each pixel, and
wherein in the second image generation processing, at least one of the brightness, chromaticity, and hue of each pixel included in the fourth image group of in the sample comparison image is changed according to the calorimetric information of each pixel.

20. The dental colorimetry program according to claim 14, wherein in the display control processing, a reference input section for inputting the reference colorimetric information on a screen displaying the vital tooth comparison image is displayed.

21. The dental colorimetry program according to claim 14, wherein in the display control processing, a condition input section for inputting the predetermined condition on a screen displaying the vital tooth comparison image is displayed.

22. The dental colorimetry program according to claim 15, further comprising:
region-specifying processing for specifying a region on a vital tooth to be measured, the region included in an acquired image of the oral cavity acquired by an image acquisition apparatus;
measurement-region setting processing for defining at least one measurement region in the specified region on the vital tooth; and
sample selection processing for selecting at least one tooth sample approximating a spectrum of the measurement region from a plurality of tooth samples registered in advance,
wherein in the second extraction processing, the reference calorimetric information and calorimetric information of the tooth sample are compared for each pixel.
